(19) United States
(12) Patent Application Publication
(10) Pub. No.: US 2025/0076649 A1
(43) Pub. Date: Mar. 6, 2025

(54) WAVEGUIDE DISPLAY WITH MULTIPLE JOINED FIELDS OF VIEW IN A SINGLE SUBSTRATE

(71) Applicant: Meta Platforms Technologies, LLC, Menlo Park, CA (US)

(72) Inventors: Edward Winghong LAO, South San Francisco, CA (US); Xiaoyue DING, Redmond, WA (US); Bo ZHAO, Seattle, WA (US); Jilin YANG, Bellevue, WA (US)

(21) Appl. No.: 18/459,247

(22) Filed: Aug. 31, 2023

(51) Int. Cl. G02B 27/01; F21V 8/00

(52) U.S. Cl. CPC G02B 27/0172; G02B 6/0016; G02B 27/0081; G02B 27/0093; G02B 2027/0125; G02B 2027/0178

(57) ABSTRACT

A waveguide display includes a substrate, one or more projectors for projecting display light for different fields of view, two or more input gratings configured to couple the display light for different fields of view into the substrate, and a two-dimensional grating characterized by three or more different grating vectors that include grating vectors same as the grating vectors of the two or more input gratings. The two-dimensional grating is configured to couple the display light for different fields of view out of the substrate at a two-dimensional array of locations of the substrate. The two-dimensional grating includes a two-dimensional array of grating elements aligned along a plurality of directions or a plurality of layers of one-dimensional gratings characterized by different grating vectors.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using diffractive optical elements, such as volume holographic gratings and/or surface-relief gratings. Light from the surrounding environment may pass through a see-through region of the waveguide and reach the user's eyes as well.

### SUMMARY

This disclosure relates generally to waveguide-based near-eye display systems. More specifically, techniques disclosed herein relate to waveguide-based near-eye display systems that include two-dimensions grating couplers to support multiple fields of view, thereby increasing the total field of view while reducing the number of waveguides used to support the multiple fields of view. Various inventive embodiments are described herein, including devices, systems, materials, structures, methods, processes, and the like.

According to certain embodiments, a waveguide display may include a substrate transparent to visible light, a first projector configured to generate display light for a first field of view (FOV) of the waveguide display, a first input grating characterized by a first grating vector and configured to couple the display light for the first FOV into the substrate, a second projector configured to generate display light for a second FOV of the waveguide display that is different from the first FOV, a second input grating characterized by a second grating vector and configured to couple the display light for the second FOV into the substrate, and a two-dimensional grating having the first grating vector, the second grating vector, and a third grating vector. The first grating vector, the second grating vector, and the third grating vector may form a closed triangle. The two-dimensional grating may be configured to couple the display light for the first FOV out of the substrate at a first two-dimensional array of locations of the substrate, and couple the display light for the second FOV out of the substrate at a second two-dimensional array of locations of the substrate. The two-dimensional grating may include a two-dimensional array of grating elements aligned along a plurality of directions, or a plurality of layers of one-dimensional gratings characterized by different grating vectors.

According to certain embodiments, a waveguide display may include a substrate transparent to visible light, a first input grating characterized by a first grating vector and configured to couple display light for a first field of view (FOV) of the waveguide display into the substrate, a second input grating characterized by a second grating vector and configured to couple display light for a second FOV of the waveguide display into the substrate, and a two-dimensional grating having the first grating vector, the second grating vector, and a third grating vector. The first input grating, the second input grating, and the two-dimensional grating may be formed on or in the substrate. The first grating vector, the second grating vector, and the third grating vector may form a closed triangle. The two-dimensional grating may be configured to couple the display light for the first FOV out of the substrate at a first two-dimensional array of locations of the substrate. The two-dimensional grating may further be configured to couple the display light for the second FOV out of the substrate at a second two-dimensional array of locations of the substrate.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates an example of an optical see-through augmented reality system including a waveguide display for exit pupil expansion according to certain embodiments.

FIG. 6A illustrates an example of a near-eye display device including a waveguide display according to certain embodiments.

FIG. 6B illustrates an example of a near-eye display device including a waveguide display according to certain embodiments.

FIG. 7 illustrates an example of an image source assembly in an augmented reality system according to certain embodiments.

FIG. 8A illustrates an example of an optical see-through augmented reality system including a waveguide display and gratings for exit pupil expansion according to certain embodiments.

FIG. 8B illustrates an example of an eyebox including two-dimensional replicated exit pupils according to certain embodiments.

FIG. 9A illustrates an example of a waveguide display including a waveguide and a grating coupler formed on the waveguide.

FIG. 9B illustrates wave vectors of light that may be guided by the waveguide of FIG. 9A.

FIG. 10 is a perspective view of an example of a waveguide display with grating couplers for exit pupil expansion.

FIG. 11A illustrates an example of a waveguide display with gratings for pupil expansion.

FIG. 11B illustrates examples of wave vectors of display light guided by the waveguide display of FIG. 11A.

FIG. 12A is a front view of an example of a grating-based waveguide display including two image projectors.

FIG. 12B is a side view of the example of the grating-based waveguide display of FIG. 12A.

FIG. 13 illustrates an example of a grating-based waveguide display including two image projectors.

FIG. 14A is a front view of an example of a grating-based waveguide display including a single image projector and gratings for field-of-view stitching.

FIG. 14B is a side view of the example of grating-based waveguide display of FIG. 14A.

FIG. 15A illustrates an example of a waveguide display including a two-dimensional grating formed on a waveguide according to certain embodiments.

FIG. 15B illustrates an example of a waveguide display including a two-dimensional grating for two-dimensional pupil expansion and output coupling according to certain embodiments.

FIGS. 16A-16F illustrate examples of waveguide displays including a two-dimensional grating and a waveguide to support multiple fields of view according to certain embodiments.

FIG. 17A illustrates an example of a waveguide display including a two-dimensional grating supporting multiple fields of view according to certain embodiments.

FIG. 17B illustrates an example of the field of view of a waveguide display including a two-dimensional grating according to certain embodiments.

FIG. 17C illustrates another example of the field of view of a waveguide display including a two-dimensional grating according to certain embodiments.

FIGS. 18A-18C illustrate examples of waveguide displays including two-dimensional gratings according to certain embodiments.

FIG. 19 illustrates examples of two-dimensional gratings that may be used to implement the waveguide displays disclosed herein according to certain embodiments.

FIG. 20 is a simplified block diagram of an electronic system of an example of a near-eye display according to certain embodiments.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to waveguide-based near-eye display systems. More specifically, techniques disclosed herein relate to waveguide-based near-eye display systems that include two-dimensional gratings to support multiple fields of view, thereby increasing the total field of view while reducing the number of waveguides used to support the multiple fields of view. Various inventive embodiments are described herein, including devices, systems, materials, structures, methods, processes, and the like.

In near-eye display systems, it is generally desirable to expand the eyebox, improve image quality (e.g., resolution and contrast), reduce physical size, improve power efficiency, and increase the field of view (FOV). In a waveguide-based near-eye display system, display light of projected images may be coupled into a waveguide, propagate within the waveguide, and be coupled out of the waveguide at different locations to replicate exit pupils and expand the eyebox. In some implementations of the waveguide-based near eye display system, display light of the projected images may be coupled into or out of a waveguide (e.g., a substrate) using, for example, refractive optical elements (e.g., prisms), diffractive optical elements (e.g., gratings), or partial reflectors (e.g., transflective mirrors). The display light coupled into the waveguide may propagate within the waveguide through total internal reflection at surfaces of the waveguide, and may, for example, be partially diffracted by gratings when the display light propagating within the waveguide reaches the gratings. The undiffracted portion of the display light may continue to propagate within the waveguide through total internal reflection and may be partially diffracted when the display light reaches another grating. Diffractive grating couplers, such as surface-relief gratings (SRGs), polarization volume holograms (PVHs), volume Bragg gratings (VBGs), or polymer dispersed liquid crystal (PDLC) gratings, may have inherent advantages compared to traditional refractive solutions, such as using small projectors, pupil replication capability to achieve a large eyebox, low thickness (e.g., ≤0.5 mm), see-through transparency, and the like. Two or more one-dimensional or two-dimensional gratings may be used to expand the eyebox in two dimensions. In a waveguide-based near-eye display system for augmented reality applications, light from the surrounding environment may also pass through at least a see-through region of the waveguide display (e.g., a transparent substrate) and reach the eyebox and the user's eyes.

For waveguide-based near eye display systems using projectors with circular pupils (as in most projectors), three diffractive gratings may be used to couple the display light and achieve two-dimensional pupil expansion to fill the eyebox. For example, a projector may have an exit pupil with a diameter about 2 mm, and a diffractive coupler-based waveguide display including an input grating, a fold grating, and an output grating may expand the pupil to fill a 17 mm×12 mm eyebox. Each of the input grating, fold grating, and output grating may have its own periodicity and tilt angle (and thus its own grating vector). In some embodiments, the fold grating and the output grating may overlap in at least some regions. The sum of the grating vectors (k-vectors) of the three gratings may be equal to 0 for angle preservation such that the angles of the input beam to the waveguide and the angles of the output beam from the waveguide may be about the same.

Waveguide displays using diffractive optical elements may generally have limited fields of view due to, for example, limited angular/wavelength bandwidths of the diffractive optical elements and limited angular ranges of light supported by the waveguides. For example, gratings such as VBGs may have a narrow angular/wavelength bandwidth, and the propagation angles of display light within a single waveguide may be bounded by the critical angle for total internal reflection (TIR) and the grazing angle. Diffractive optical elements may also have high light dispersion, and thus the fields of view for different colors may be reduced or partially clipped due to the light dispersion and the limited angular ranges of light supported by the waveguide. In order to support a large field of view by a single waveguide, the waveguide may need to have a high refractive index, which may be more expensive and more difficult to make.

In some implementations, the full FOV range of a waveguide display may be divided into two or more FOV ranges to be covered by two or more sets of gratings and two or more waveguides. The two or more FOV ranges may be stitched together to provide the full field of view. For each FOV range, a set of gratings and one or more waveguides may be used to expand the exit pupil in two dimensions to fill an eyebox. For example, a first grating may be used to couple display light into a waveguide, a second grating (e.g., a fold grating) may be used to expand the exit pupil in one (e.g., horizontal or vertical) direction, and a third grating may be used to expand the exit pupil in another (e.g., vertical or horizontal) direction. The first grating. second grating, and third grating may be formed on one or two surfaces of the waveguide. In some embodiments, to reduce certain optical artifacts, the two or more sets of gratings may be configured such that the two or more FOV ranges of the full field of view may partially overlap. As such, even if there is a misalignment of the two or more FOV ranges of the full FOV caused by some manufacture errors, the full FOV can still be supported. In some implementations, the full FOV range of a waveguide display may be covered by a single projector. In some implementations, the full FOV may be divided into two or more FOV ranges to be covered by two or more projectors, where light from each projector may be coupled into a waveguide by a respective input coupler.

Multiple waveguides and multiple projectors and gratings may be used to support multiple FOVs to achieve a large overall FOV. For example, two waveguides and the corresponding gratings may be used to cover the full FOV for blue light, two waveguides and the corresponding gratings may be used to cover the full FOV for red light, and the full FOV for green light may be covered by another two waveguides and corresponding gratings, or may be covered by the waveguides and gratings for blue light and/or red light. Therefore, four or more waveguides may be needed for each eye, and eight or more waveguides may be needed for binocular display. In some implementations, one waveguide may be used to cover one half of the full FOV for red, green, and blue (RGB) light, and another waveguide may be used to cover the other half of the full FOV for RGB light, such that two waveguides may be used for a monocular display and four waveguides may be used for a binocular display. Using multiple waveguides and the corresponding projectors and gratings may increase the thickness (and thus weight), manufacturing cost, and alignment difficulty, and may also reduce overall see-through transparency and introduce more display artifacts, such as ghost images, glints, rainbow images, and the like.

According to certain embodiments, a waveguide display may include a waveguide and a two-dimensional (2-D) grating having multiple (e.g., three or more) different grating vectors for replicating the exit pupil of the display light for multiple FOVs in two dimensions. Multiple grating vectors of the 2-D grating may form a closed polygon (e.g., a triangle). Display light for different FOVs may be coupled into the waveguide by respective input gratings, where the grating vector of each input grating may be similar to a grating vector of the multiple grating vectors of the 2-D grating, such that the grating vector of the input grating and two or more grating vectors of the 2-D grating may form a closed polygon (e.g., triangle) for angle preservation. As such, the 2-D grating may be able to diffract the display light coupled into the waveguide by the input gratings in two or more directions, to perform 2-D pupil replication of display light for two or more different FOVs that is coupled into the waveguide by two or more input gratings.

In some embodiments, the 2-D grating may include a two-dimensional lattice structure that includes a 2-D array of the grating elements, where the grating elements may align long multiple directions at different pitches to function as multiple grating structures having multiple grating vectors. Therefore, the 2-D grating may be able to diffract light that is from multiple

FOVs and is coupled into the waveguide by multiple input gratings, where each input grating may be used to couple display light for a respective FOV and may be characterized by a grating vector that matches one of the multiple grating vectors of the 2-D grating. Therefore, a waveguide and the gratings on the waveguide may be able to support multiple FOVs to achieve a desired overall FOV coverage.

In one example, a first field of view FOV₁ of the waveguide display may be supported by a first display projector assembly DPA₁, a first input grating, and the 2-D grating. The first field of view FOV₁ may be about a half of the desired overall FOV of the waveguide display. The first input grating may be on the same waveguide as the 2-D grating and may have a grating vector V₁, whereas the 2-D grating may have grating vectors V₀, V₁, and V₂ that may form a closed triangle. A second field of view FOV₂ of the waveguide display may be supported by a second display projector assembly DPA₂, a second input grating, and the 2-D grating. The second field of view FOV₂ may be about another half of the desired overall FOV. The second input grating may have a grating vector V₀, and may be on the same waveguide as the first input grating and the 2-D grating. The 2-D grating having grating vectors V₀, V₁, and V₂ may support both FOV₁ and FOV₂. In this way, a single waveguide including two input gratings and a 2-D grating formed thereon and two display projector assemblies (DPAs) can support the full FOV that may otherwise need to be supported by at least two waveguides and two sets of gratings.

In another example, the full FOV of the waveguide display may be achieved by stitching three or more FOVs. For example, two of the three or more FOVs may be supported by a single waveguide including two input gratings and a 2-D grating formed thereon and two DPAs as described above. A third input grating with a grating V₂ may be formed on the same waveguide and may be used to couple display light for a third FOV (FOV₃) of the waveguide display from a third DPA (DPA₃) into the waveguide, where the 2-D grating having grating vectors V₀, V₁, and V₂ may replicate the display light for FOV₃ in two dimensions. The third FOV (FOV₃) may be stitched together with first two FOVs to further increase the full FOV of the waveguide display, or may be used as an inset FOV to provide improved display quality for a center FOV the waveguide display. Without using the 2-D output gratings disclosed herein, three or more waveguides may be needed to achieve the same full FOV.

Techniques described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through). In some AR systems, the artificial images may be presented to users using an LED-based display subsystem.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

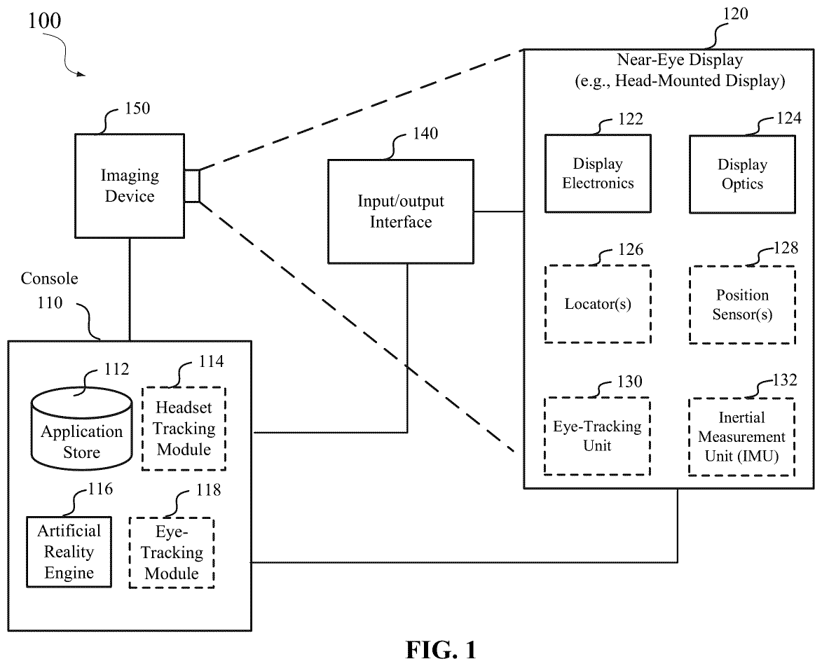

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

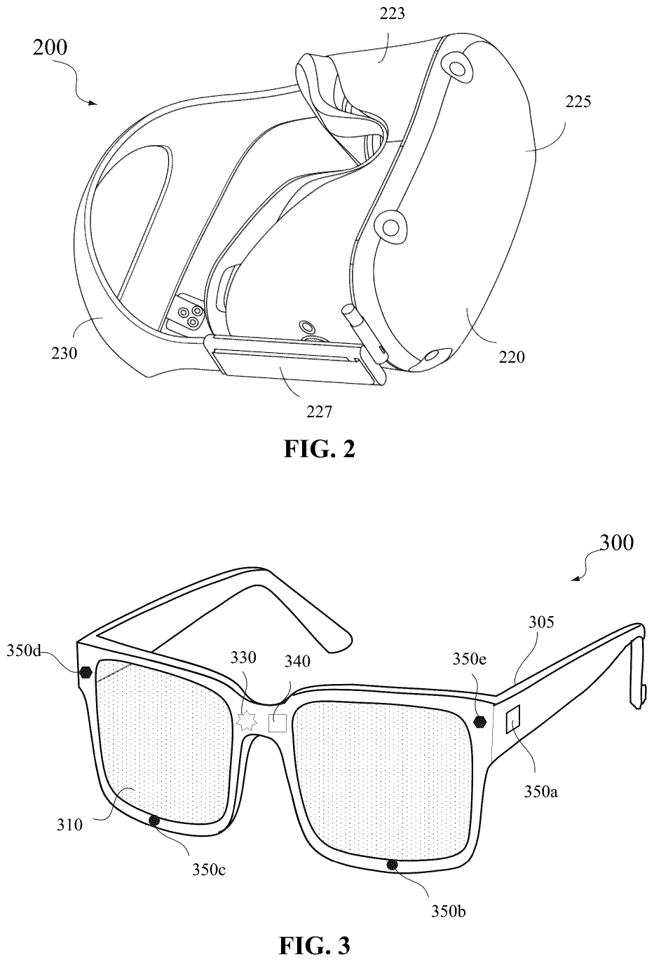

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two Foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to determine the eye's orientation more accurately.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

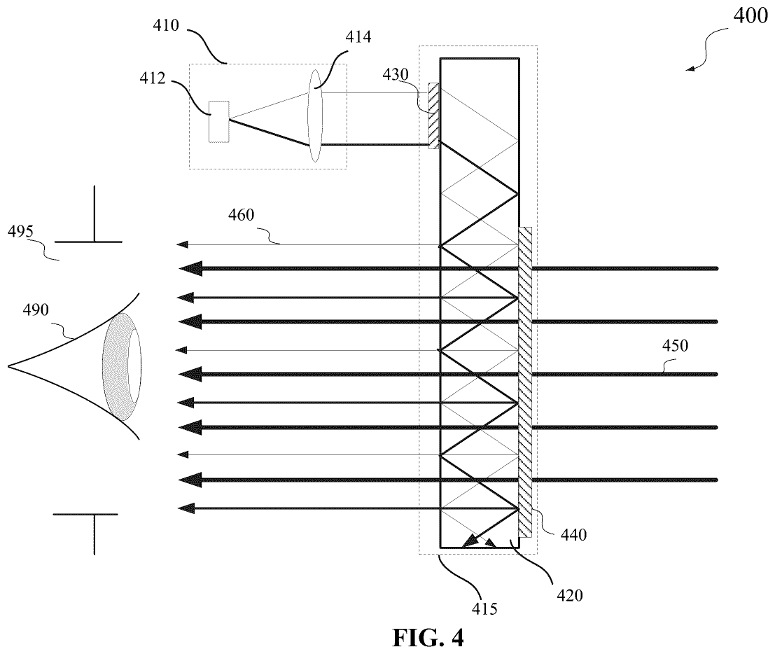

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly (methyl methacrylate) (PMMA), crystal, SiC, or ceramic. A thickness of the substrate may range from, for example, less than about 1 mm to about 10 mm or more. Substrate 420 may be transparent to visible light.

Substrate 420 may include or may be coupled to a plurality of output couplers 440. each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements (DOEs), prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

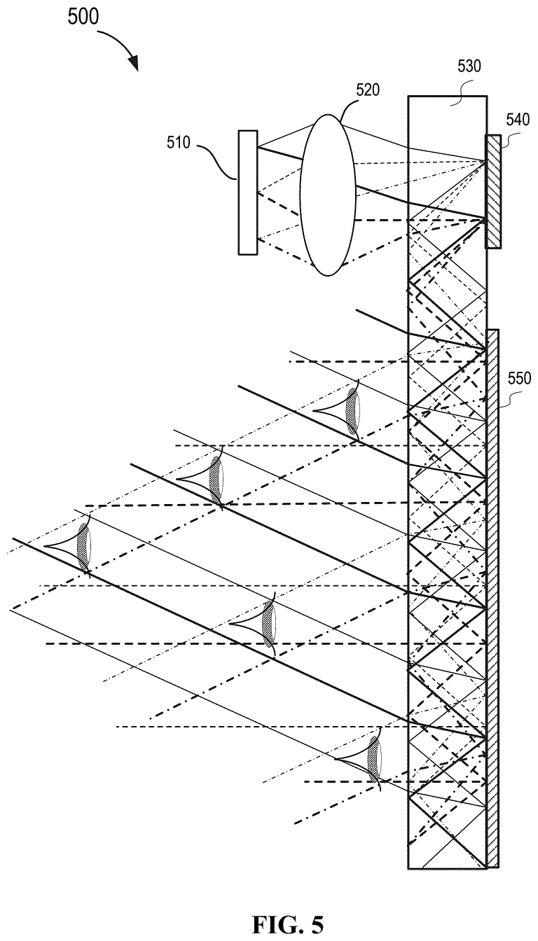

FIG. 5 illustrates an example of an optical see-through augmented reality system 500 including a waveguide display for exit pupil expansion according to certain embodiments. Augmented reality system 500 may be similar to augmented reality system 500, and may include the waveguide display and a projector that may include a light source or image source 510 and projector optics 520. The waveguide display may include a substrate 530, an input coupler 540, and a plurality of output couplers 550 as described above with respect to augmented reality system 500. While FIG. 5 only shows the propagation of light from a single field of view, FIG. 5 shows the propagation of light from multiple fields of view.

FIG. 5 shows that the exit pupil is replicated by output couplers 550 to form an aggregated exit pupil or eyebox, where different regions in a field of view (e.g., different pixels on image source 510) may be associated with different respective propagation directions towards the eyebox, and light from a same field of view (e.g., a same pixel on image source 510) may have a same propagation direction for the different individual exit pupils. Thus, a single image of image source 510 may be formed by the user's eye located anywhere in the eyebox, where light from different individual exit pupils and propagating in the same direction may be from a same pixel on image source 510 and may be focused onto a same location on the retina of the user's eye. FIG. 5 shows that the image of the image source is visible by the user's eye even if the user's eye moves to different locations in the eyebox.

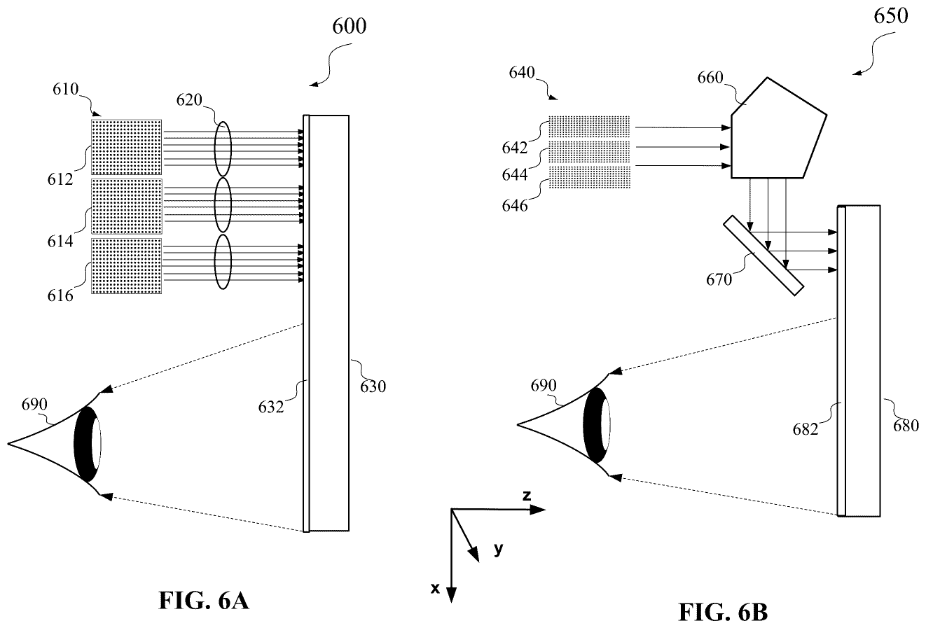

FIG. 6A illustrates an example of a near-eye display (NED) device 600 including a waveguide display 630 according to certain embodiments. NED device 600 may be an example of near-eye display 120, augmented reality system 400, or another type of display device. NED device 600 may include a light source 610, projection optics 620, and waveguide display 630. Light source 610 may include multiple panels of light emitters for different colors, such as a panel of red light emitters 612, a panel of green light emitters 614, and a panel of blue light emitters 616. The red light emitters 612 are organized into an array; the green light emitters 614 are organized into an array; and the blue light emitters 616 are organized into an array. The dimensions and pitches of light emitters in light source 610 may be small. For example, each light emitter may have a diameter less than 2 μm (e.g., about 1.2 μm) and the pitch may be less than 2 μm (e.g., about 1.5 μm). As such, the number of light emitters in each red light emitters 612, green light emitters 614, and blue light emitters 616 can be equal to or greater than the number of pixels in a display image, such as 960×720, 1280×720, 1440×1080, 2020×1080, 2160×1080, or 2560×1080 pixels. Thus, a display image may be generated simultaneously by light source 610. A scanning element may not be used in NED device 600.

Before reaching waveguide display 630, the light emitted by light source 610 may be conditioned by projection optics 620, which may include a lens array. Projection optics 620 may collimate or focus the light emitted by light source 610 to waveguide display 630, which may include a coupler 632 for coupling the light emitted by light source 610 into waveguide display 630. The light coupled into waveguide display 630 may propagate within waveguide display 630 through, for example, total internal reflection as described above with respect to FIG. 4. Coupler 632 may also couple portions of the light propagating within waveguide display 630 out of waveguide display 630 and towards user's eye 690.

FIG. 6B illustrates an example of a near-eye display (NED) device 650 including a waveguide display 680 according to certain embodiments. In some embodiments, NED device 650 may use a scanning mirror 670 to project light from a light source 640 to an image field where a user's eye 690 may be located. NED device 650 may be an example of near-eye display 120, augmented reality system 400, or another type of display device. Light source 640 may include one or more rows or one or more columns of light emitters of different colors, such as multiple rows of red light emitters 642, multiple rows of green light emitters 644, and multiple rows of blue light emitters 646. For example, red light emitters 642, green light emitters 644, and blue light emitters 646 may each include N rows, each row including, for example, 2560 light emitters (pixels). The red light emitters 642 are organized into an array; the green light emitters 644 are organized into an array; and the blue light emitters 646 are organized into an array. In some embodiments, light source 640 may include a single line of light emitters for each color. In some embodiments, light source 640 may include multiple columns of light emitters for each of red, green, and blue colors, where each column may include, for example, 1080 light emitters. In some embodiments, the dimensions and/or pitches of the light emitters in light source 640 may be relatively large (e.g., about 3-5 μm) and thus light source 640 may not include sufficient light emitters for simultaneously generating a full display image. For example, the number of light emitters for a single color may be fewer than the number of pixels (e.g., 2560×1080 pixels) in a display image. The light emitted by light source 640 may be a set of collimated or diverging beams of light.

Before reaching scanning mirror 670, the light emitted by light source 640 may be conditioned by various optical devices, such as collimating lenses or a freeform optical element 660. Freeform optical element 660 may include, for example, a multi-facet prism or another light folding element that may direct the light emitted by light source 640 towards scanning mirror 670, such as changing the propagation direction of the light emitted by light source 640 by, for example, about 90° or larger. In some embodiments, freeform optical element 660 may be rotatable to scan the light. Scanning mirror 670 and/or freeform optical element 660 may reflect and project the light emitted by light source 640 to waveguide display 680, which may include a coupler 682 for coupling the light emitted by light source 640 into waveguide display 680. The light coupled into waveguide display 680 may propagate within waveguide display 680 through, for example, total internal reflection as described above with respect to FIG. 4. Coupler 682 may also couple portions of the light propagating within waveguide display 680 out of waveguide display 680 and towards user's eye 690.

Scanning mirror 670 may include a microelectromechanical system (MEMS) mirror or any other suitable mirrors. Scanning mirror 670 may rotate to scan in one or two dimensions. As scanning mirror 670 rotates, the light emitted by light source 640 may be directed to a different area of waveguide display 680 such that a full display image may be projected onto waveguide display 680 and directed to user's eye 690 by waveguide display 680 in each scanning cycle. For example, in embodiments where light source 640 includes light emitters for all pixels in one or more rows or columns, scanning mirror 670 may be rotated in the column or row direction (e.g., x or y direction) to scan an image. In embodiments where light source 640 includes light emitters for some but not all pixels in one or more rows or columns, scanning mirror 670 may be rotated in both the row and column directions (e.g., both x and y directions) to project a display image (e.g., using a raster-type scanning pattern).

NED device 650 may operate in predefined display periods. A display period (e.g., display cycle) may refer to a duration of time in which a full image is scanned or projected. For example, a display period may be a reciprocal of the desired frame rate. In NED device 650 that includes scanning mirror 670, the display period may also be referred to as a scanning period or scanning cycle. The light generation by light source 640 may be synchronized with the rotation of scanning mirror 670. For example, each scanning cycle may include multiple scanning steps, where light source 640 may generate a different light pattern in each respective scanning step.

In each scanning cycle, as scanning mirror 670 rotates, a display image may be projected onto waveguide display 680 and user's eye 690. The actual color value and light intensity (e.g., brightness) of a given pixel location of the display image may be an average of the light beams of the three colors (e.g., red, green, and blue) illuminating the pixel location during the scanning period. After completing a scanning period, scanning mirror 670 may revert back to the initial position to project light for the first few rows of the next display image or may rotate in a reverse direction or scan pattern to project light for the next display image, where a new set of driving signals may be fed to light source 640. The same process may be repeated as scanning mirror 670 rotates in each scanning cycle. As such, different images may be projected to user's eye 690 in different scanning cycles.

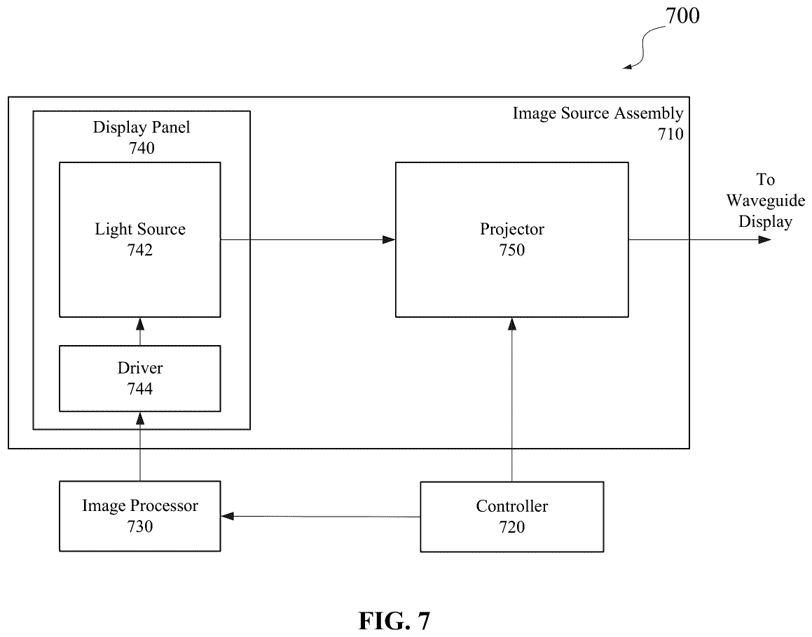

FIG. 7 illustrates an example of an image source assembly 710 in a near-eye display system 700 according to certain embodiments. Image source assembly 710 may include, for example, a display panel 740 that may generate display images to be projected to the user's eyes, and a projector 750 that may project the display images generated by display panel 740 to a waveguide display as described above with respect to FIGS. 4-6B. Display panel 740 may include a light source 742 and a driver circuit 744 for light source 742. Light source 742 may include, for example, light source 610 or 640. Projector 750 may include, for example, freeform optical element 660, scanning mirror 670, and/or projection optics 620 described above. Near-eye display system 700 may also include a controller 720 that synchronously controls light source 742 and projector 750 (e.g., scanning mirror 670). Image source assembly 710 may generate and output an image light to a waveguide display (not shown in FIG. 7), such as waveguide display 630 or 680. As described above, the waveguide display may receive the image light at one or more input-coupling elements, and guide the received image light to one or more output-coupling elements. The input and output coupling elements may include, for example, a diffraction grating, a holographic grating, a prism, or any combination thereof. The input-coupling element may be chosen such that total internal reflection occurs with the waveguide display. The output-coupling element may couple portions of the total internally reflected image light out of the waveguide display.

As described above, light source 742 may include a plurality of light emitters arranged in an array or a matrix. Each light emitter may emit monochromatic light, such as red light, blue light, green light, infra-red light, and the like. While RGB colors are often discussed in this disclosure, embodiments described herein are not limited to using red, green, and blue as primary colors. Other colors can also be used as the primary colors of near-eye display system 700. In some embodiments, a display panel in accordance with an embodiment may use more than three primary colors. Each pixel in light source 742 may include three subpixels that include a red micro-LED, a green micro-LED, and a blue micro-LED. A semiconductor LED generally includes an active light emitting layer within multiple layers of semiconductor materials. The multiple layers of semiconductor materials may include different compound materials or a same base material with different dopants and/or different doping densities. For example, the multiple layers of semiconductor materials may include an n-type material layer, an active region that may include hetero-structures (e.g., one or more quantum wells), and a p-type material layer. The multiple layers of semiconductor materials may be grown on a surface of a substrate having a certain orientation. In some embodiments, to increase light extraction efficiency, a mesa that includes at least some of the layers of semiconductor materials may be formed.

Controller 720 may control the image rendering operations of image source assembly 710, such as the operations of light source 742 and/or projector 750. For example, controller 720 may determine instructions for image source assembly 710 to render one or more display images. The instructions may include display instructions and scanning instructions. In some embodiments, the display instructions may include an image file (e.g., a bitmap file). The display instructions may be received from, for example, a console, such as console 110 described above with respect to FIG. 1. The scanning instructions may be used by image source assembly 710 to generate image light. The scanning instructions may specify, for example, a type of a source of image light (e.g., monochromatic or polychromatic), a scanning rate, an orientation of a scanning apparatus, one or more illumination parameters, or any combination thereof. Controller 720 may include a combination of hardware, software, and/or firmware not shown here so as not to obscure other aspects of the present disclosure.

In some embodiments, controller 720 may be a graphics processing unit (GPU) of a display device. In other embodiments, controller 720 may be other kinds of processors. The operations performed by controller 720 may include taking content for display and dividing the content into discrete sections. Controller 720 may provide to light source 742 scanning instructions that include an address corresponding to an individual source element of light source 742 and/or an electrical bias applied to the individual source element. Controller 720 may instruct light source 742 to sequentially present the discrete sections using light emitters corresponding to one or more rows of pixels in an image ultimately displayed to the user. Controller 720 may also instruct projector 750 to perform different adjustments of the light. For example, controller 720 may control projector 750 to scan the discrete sections to different areas of a coupling element of the waveguide display (e.g., waveguide display 680) as described above with respect to FIG. 6B. As such, at the exit pupil of the waveguide display, each discrete portion is presented in a different respective location. While each discrete section is presented at a different respective time, the presentation and scanning of the discrete sections occur fast enough such that a user's eye may integrate the different sections into a single image or series of images.

Image processor 730 may be a general-purpose processor and/or one or more application-specific circuits that are dedicated to performing the features described herein. In one embodiment, a general-purpose processor may be coupled to a memory to execute software instructions that cause the processor to perform certain processes described herein. In another embodiment, image processor 730 may be one or more circuits that are dedicated to performing certain features. While image processor 730 in FIG. 7 is shown as a stand-alone unit that is separate from controller 720 and driver circuit 744, image processor 730 may be a sub-unit of controller 720 or driver circuit 744 in other embodiments. In other words, in those embodiments, controller 720 or driver circuit 744 may perform various image processing functions of image processor 730. Image processor 730 may also be referred to as an image processing circuit.

In the example shown in FIG. 7, light source 742 may be driven by driver circuit 744, based on data or instructions (e.g., display and scanning instructions) sent from controller 720 or image processor 730. In one embodiment, driver circuit 744 may include a circuit panel that connects to and mechanically holds various light emitters of light source 742. Light source 742 may emit light in accordance with one or more illumination parameters that are set by the controller 720 and potentially adjusted by image processor 730 and driver circuit 744. An illumination parameter may be used by light source 742 to generate light. An illumination parameter may include, for example, source wavelength, pulse rate, pulse amplitude, beam type (continuous or pulsed), other parameter(s) that may affect the emitted light, or any combination thereof. In some embodiments, the source light generated by light source 742 may include multiple beams of red light, green light, and blue light, or any combination thereof.

Projector 750 may perform a set of optical functions, such as focusing, combining, conditioning, or scanning the image light generated by light source 742. In some embodiments, projector 750 may include a combining assembly, a light conditioning assembly, or a scanning mirror assembly. Projector 750 may include one or more optical components that optically adjust and potentially re-direct the light from light source 742. One example of the adjustment of light may include conditioning the light, such as expanding, collimating, correcting for one or more optical errors (e.g., field curvature, chromatic aberration, etc.), some other adjustments of the light, or any combination thereof. The optical components of projector 750 may include, for example, lenses, mirrors, apertures, gratings, or any combination thereof.

Projector 750 may redirect image light via its one or more reflective and/or refractive portions so that the image light is projected at certain orientations toward the waveguide display. The location where the image light is redirected toward the waveguide display may depend on specific orientations of the one or more reflective and/or refractive portions. In some embodiments, projector 750 includes a single scanning mirror that scans in at least two dimensions. In other embodiments, projector 750 may include a plurality of scanning mirrors that each scan in directions orthogonal to each other. Projector 750 may perform a raster scan (horizontally or vertically), a bi-resonant scan, or any combination thereof. In some embodiments, projector 750 may perform a controlled vibration along the horizontal and/or vertical directions with a specific frequency of oscillation to scan along two dimensions and generate a two-dimensional projected image of the media presented to user's eyes. In other embodiments, projector 750 may include a lens or prism that may serve similar or the same function as one or more scanning mirrors. In some embodiments, image source assembly 710 may not include a projector, where the light emitted by light source 742 may be directly incident on the waveguide display.

In a waveguide-based near-eye display system, display light of projected images may be coupled into a waveguide, propagate within the waveguide, and be coupled out of the waveguide at different locations to replicate exit pupils and expand the eyebox. In some implementations of the waveguide-based near eye display system, display light of the projected images may be coupled into or out of a waveguide (e.g., a substrate) using, for example, refractive optical elements (e.g., prisms), diffractive optical elements (e.g., gratings), or partial reflectors (e.g., transflective mirrors). The display light coupled into the waveguide may propagate within the waveguide through total internal reflection at surfaces of the waveguide, and may, for example, be partially diffracted by gratings when the display light propagating within the waveguide reaches the gratings. The undiffracted portion of the display light may continue to propagate within the waveguide through total internal reflection and may be partially diffracted when the display light reaches another grating. Diffractive grating couplers, such as surface-relief gratings (SRGs), polarization volume holograms (PVHs), volume Bragg gratings (VBGs), or polymer dispersed liquid crystal (PDLC) gratings, may have inherent advantages compared to traditional refractive solutions, such as using small projectors, pupil replication capability to achieve a large eyebox, low thickness (e.g., ≤0.5 mm), see-through transparency, and the like. Two or more one-dimensional or two-dimensional gratings may be used to expand the eyebox in two dimensions. In a waveguide-based near-eye display system for augmented reality applications, light from the surrounding environment may also pass through at least a see-through region of the waveguide display (e.g., a transparent substrate) and reach the eyebox and the user's eyes.

For waveguide-based near eye display systems using projectors with circular pupils (as in most projectors), three diffractive gratings may be used to couple the display light and achieve two-dimensional pupil expansion to fill the eyebox. For example, a projector may have an exit pupil with a diameter about 2 mm, and a diffractive coupler-based waveguide display including an input grating, a fold grating, and an output grating may expand the pupil to fill a 17 mm×12 mm eyebox. Each of the input grating, fold grating, and output grating may have its own periodicity and tilt angle (and thus its own grating vector). In some embodiments, the fold grating and the output grating may overlap in at least some regions. The sum of the grating vectors (k-vectors) of the three gratings may be equal to 0 for angle preservation such that the angles of the input beam to the waveguide and the angles of the output beam from the waveguide may be about the same.

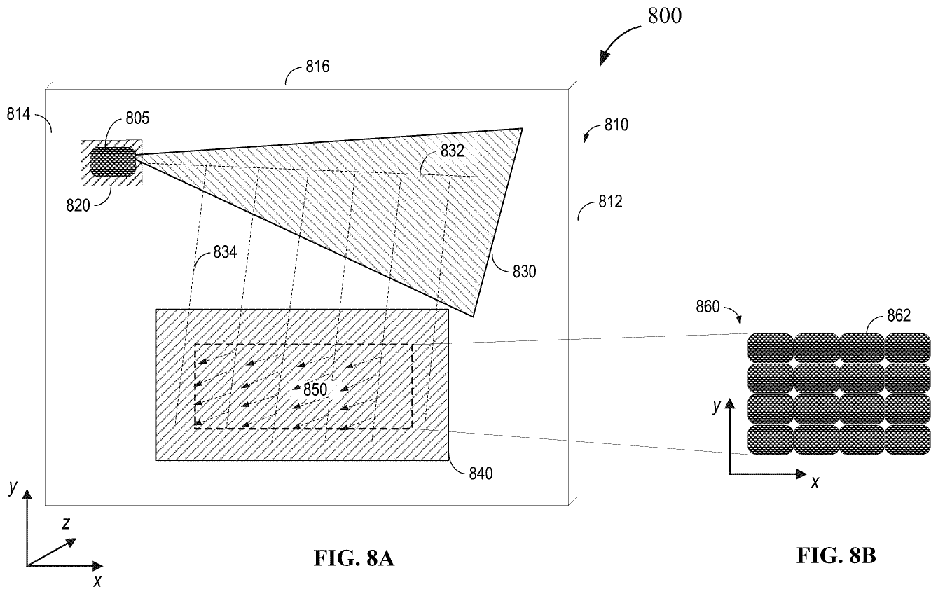

FIG. 8A illustrates an example of an optical see-through augmented reality system including a waveguide display 800 and surface-relief gratings for exit pupil expansion according to certain embodiments. Waveguide display 800 may include a substrate 810 (e.g., a waveguide), which may be similar to substrate 420 or 530, or waveguide display 680. Substrate 810 may be transparent to visible light and may include, for example, a glass, quartz, plastic, polymer, PMMA, ceramic, Si₃N₄, SiC, or crystal substrate. Substrate 810 may be a flat substrate or a curved substrate. Substrate 810 may include two opposing broadside surfaces that include a first surface 812 and a second surface 814, and multiple sidewalls surfaces 816 that may be perpendicular to the broadside surfaces. Display light may be coupled into substrate 810 by an input coupler 820, and may be reflected by first surface 812 and second surface 814 through total internal reflection, such that the display light may propagate within substrate 810. Input coupler 820 may include a grating, a refractive coupler (e.g., a wedge or a prism), or a reflective coupler (e.g., a reflective surface having a slant angle with respect to substrate 810). For example, in one embodiment, input coupler 820 may include a prism that may couple display light of different colors into substrate 810 at a same refraction angle. In another example, input coupler 820 may include a grating coupler that may diffract light of different colors into substrate 810 at different directions. Input coupler 820 may have a coupling efficiency of greater than 10%, 20%, 30%, 50%, 75%, 90%, or higher for visible light.

Waveguide display 800 may also include a first output grating 830 and a second output grating 840 positioned on one or two surfaces (e.g., first surface 812 and second surface 814) of substrate 810 for expanding incident display light beam in two dimensions in order to fill an eyebox with the display light. First output grating 830 may be configured to expand at least a portion of the display light beam along one direction, such as approximately in the x direction. Display light coupled into substrate 810 may propagate in a direction shown by a line 832. While the display light propagates within substrate 810 along a direction shown by line 832, a portion of the display light may be diffracted by a region of first output grating 830 towards second output grating 840 as shown by a line 834 each time the display light propagating within substrate 810 reaches first output grating 830. Second output grating 840 may then expand the display light from first output grating 830 in a different direction (e.g., approximately in the y direction) by diffracting a portion of the display light from an exit region 850 to the eyebox each time the display light propagating within substrate 810 reaches second output grating 840.

FIG. 8B illustrates an example of an eye box including two-dimensional replicated exit pupils. FIG. 8B shows that a single input pupil 805 may be replicated by first output grating 830 and second output grating 840 to form an aggregated exit pupil 860 that includes a two-dimensional array of individual exit pupils 862. For example, the exit pupil may be replicated in approximately the x direction by first output grating 830 and in approximately the y direction by second output grating 840. As described above, output light from individual exit pupils 862 and propagating in a same direction may be focused onto a same location in the retina of the user's eye. Thus, a single image may be formed by the user's eye from the output light in the two-dimensional array of individual exit pupils 862.

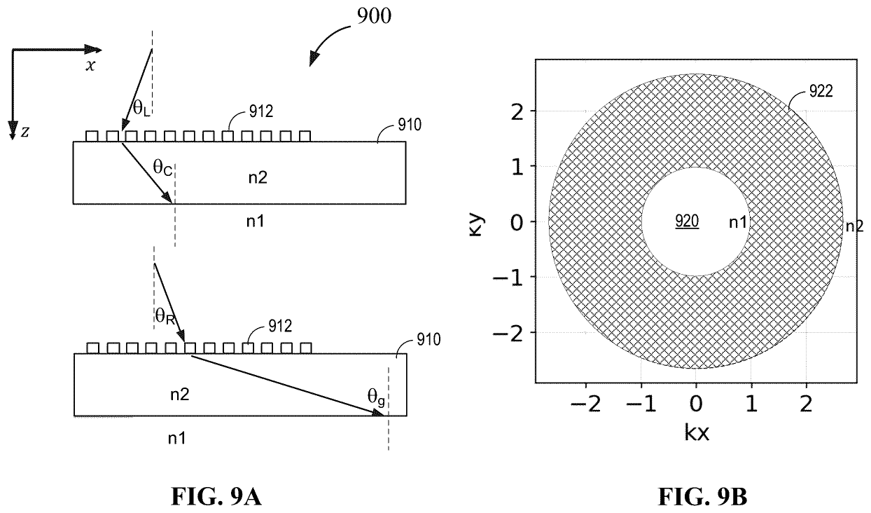

FIG. 9A illustrates an example of a waveguide display 900 including a waveguide 910 and a grating coupler 912 formed on waveguide 910. Waveguide 910 may include a substrate that is transparent to visible light and may have a refractive index n2, where the medium (e.g., air) surrounding waveguide 910 may have a refractive index about n1 (e.g., about 1.0). Grating coupler 912 may be an SRG, VBG, PVH, PDLC, metasurface, and the like.

As shown in FIG. 9A, waveguide 910 may only guide light having certain propagation directions within waveguide through total internal reflections. The minimum angle of incidence of the guided light at the top or bottom surface of waveguide 910 may be the critical angle θ_{C} at the interface between waveguide 910 and the surrounding medium (e.g., air). Display light for the left field of view and having an angle of incidence θ_{L} may be diffracted by grating coupler 912 to propagate within waveguide 910 at critical angle θ_{C}. Display light for the left field of view having angles of incidence greater than θ_{L} may be diffracted by grating coupler 912 into waveguide 910 and incident on a surface of waveguide 910 at angles of incidence less than the critical angle θ_{C}, and thus may leak out of the waveguide because the total-internal-reflection condition is not met.

As also shown in FIG. 9A, in-coupled display light that is incident on a surface of waveguide 910 at angles of incidence greater than a grazing angle θ_{g} may become evanescent, and thus may not be guided by waveguide 910. Display light for the right field of view and having an angle of incidence θ_{R} may be diffracted by grating coupler 912 to propagate within waveguide 910 at grazing angle θ_{g}. Display light for the right field of view and having angles of incidence greater than θ_{R} may be diffracted by grating coupler 912 into waveguide 910 and incident on a surface of waveguide 910 at angles of incidence greater than the grazing angle θ_{g}, and thus may become evanescent and may not be guided by waveguide 910. Therefore, the field of view of waveguide display 900 may be limited to between θ_{L} and θ_{R}.

FIG. 9B illustrates wave vectors (k-vectors) of light that may be guided by waveguide 910 of FIG. 9A. In k-space, light propagating at different angles may be represented by different wave vectors. Wave vectors of display light supported by a waveguide may be bounded by a circle 920 corresponding to the critical angle for total internal reflection (TIR), and a circle 922 corresponding to the grazing angle. For light with wave vectors outside of circle 922, the light may become evanescent. Wave vectors within circle 920 may represent light that may leak out of the waveguide because the total-internal-reflection condition is not met. Thus, the ring between circle 920 and circle 922 may represent the wave vectors of light that can be guided by the waveguide and can propagate within the waveguide through TIR. For waveguides with higher refractive indices, the critical angle (and circle 920) may be smaller and the grazing angle (and circle 922) may be larger, and thus the angular range of the display light that may be guided by the waveguide may be larger. Waveguides with large refractive indices may be more expensive and more difficult to fabricate, and may not be able to achieve the desired full FOV of the waveguide display.

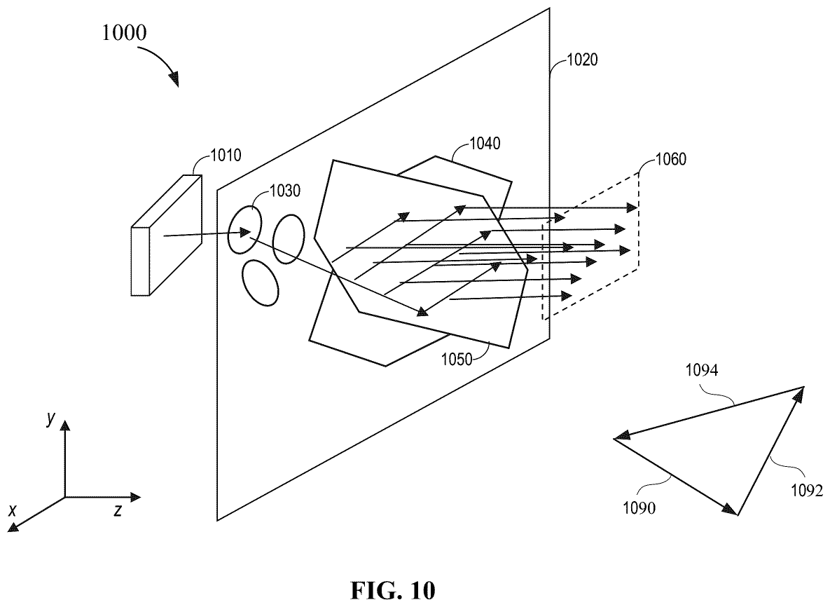

FIG. 10 is a perspective view of an example of a waveguide display 1000 with grating couplers for exit pupil expansion. Waveguide display 1000 may be an example of waveguide display 800. Waveguide display 1000 may include a light source 1010, which may include, for example, an array of red micro-LEDs, an array of green micro-LEDs, and an array of blue micro-LEDs. Each array of micro-LEDs may generate an image of a corresponding color, and thus the three arrays of micro-LEDs in combination may generate a color image. Waveguide display 1000 may include a substrate 1020 with grating couplers formed thereon or coupled thereto. For example, waveguide display 1000 may include three input gratings 1030, where each input grating 1030 may be used to couple display light of a monochromatic image generated by a corresponding array of micro-LEDs into substrate 1020. The display light coupled into substrate 1020 may propagate within substrate 1020 through total internal reflection at the surfaces of substrate 1020, and may be diffracted at multiple locations along a first direction by a first output grating 1040, thereby replicating the input pupil along the first direction. The display light diffracted at different locations of first output grating 1040 may propagate in a second direction and reach a second output grating 1050, which may diffract the display light at different locations along the second direction to replicate the input pupil along the second direction and couple the display light out of substrate 1020 as described above. The diffracted light may then propagate towards an eyebox 1060. Input gratings 1030, first output grating 1040, and second output grating 1050 may include, for example, VBGs or SRGs formed at different locations on surfaces of substrate 1020, such as on two opposing broadside surfaces of substrate 1020.

Input gratings 1030, first output grating 1040, and second output grating 1050 may have corresponding grating vectors and may impart momentum to the wave vectors of the incident light to change the propagation directions of the incident light. The grating vectors of an input grating 1030, first output grating 1040, and second output grating 1050 may form a closed triangle for angle preservation. For example, each input grating 1030 may have a grating vector 1090 and may be used to couple display light of a monochromatic image generated by a corresponding array of micro-LEDs or another projector into substrate 1020. First output grating 1040 may have a grating vector 1092 and may diffract the in-coupled display light toward second output grating 1050. Second output grating 1050 may have a grating vector 1094, and may diffract the display light out of substrate 1020. Grating vectors 1090, 1092, and 1094 may form a closed triangle for angle preservation, and the wave vectors of the display light diffracted by input grating 1030, first output grating 1040, and second output grating 1050 (which impart momentums to the wave vectors according to the grating vectors) may also form a closed triangle, such that the angles of the input beam to input grating 1030 and the angles of the output beam diffracted by second output grating 1050 out of the substate 1020 may be about the same.

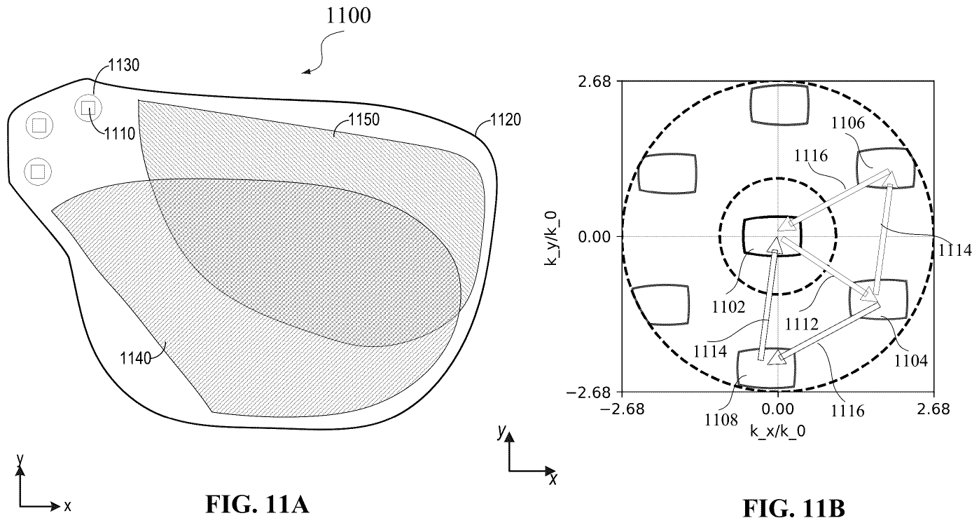

FIG. 11A illustrates an example of a waveguide display 1100 with gratings for pupil expansion. In the illustrated example, waveguide display 1100 may include three image sources 1110 (e.g., image projectors or LED arrays described above), a substrate 1120, a set of input couplers 1130 (e.g., gratings), and a set of one-dimensional gratings (e.g., a first output grating 1140 and a second output grating 1150) or one or more two-dimensional gratings for pupil expansion as described above. Input couplers 1130 and the gratings for pupil expansion may be attached to or formed (e.g., etched) in substrate 1120.

Image sources 1110 may generate images of red, green, and blue light, respectively. The images generated by image sources 1110 may be coupled into substrate 1120 by the set of input couplers 1130. Display light generated by image sources 1110 and coupled into substrate 1120 by input couplers 1130 may propagate within substrate 1120 through total internal reflection at two opposing broadside surfaces of substrate 1120. During the propagation, the display light may be partially diffracted by first output gratings 1140 and second output grating 1150 at multiple locations, and may be partially reflected to continue to propagate within substrate 1120, as described above with respect to, for example, FIGS. 4, 5, 8A, and 10.

FIG. 11B illustrates examples of wave vectors of display light guided by waveguide display 1100 of FIG. 11A. Wave vectors of light guided by substrate 1120 may be within a ring-shaped region in the k-space shown in FIG. 11B, as described above with respect to FIG. 9B. Wave vectors of an input display light frustum (e.g., within a FOV of) ±30°×±20° may be represented by a region 1102 in the k-space. The grating vector of an input coupler 1130 may be represented by a vector 1112. The light frustum of the portion of the input display light frustum diffracted by input coupler 1130 and coupled into substrate 1120 may be represented by a region 1104 in the k-space. First output grating 1140 may have a grating vector 1114. The light frustum of the portion of the display light diffracted by first output grating 1140 may be represented by a region 1106 in the k-space. Second output grating 1150 may have a vector 1116. The wave vectors of the light frustum of the portion of the display light diffracted by second output grating 1150 may be in region 1102, which is outside of the ring-shaped region, and thus the light diffracted by second output grating 1150 may not be supported by substrate 1120 and may leak out of substrate 1120.

FIG. 11B also shows that the light frustum (represented by region 1104 in the k-space) of the portion of the input display light frustum (represented by region 1102 in the k-space) diffracted by input coupler 1130 and coupled into substrate 1120 may be diffracted by second output grating 1150 (with a grating vector 1116) if the in-coupled display light reaches second output grating 1150, where the diffracted light frustum may be represented by a region 1108. The display light frustum diffracted by second output grating 1150 (represented by region 1108) may be diffracted by first output grating 1140 (with a grating vector 1114) if the display light reaches first output grating 1140, where the light frustum of the display light diffracted by first output grating 1140 may be represented by region 1102 outside of the ring-shaped region representing wave vectors supported by substrate 1120, and thus the display light may leak out substrate 1120 and propagate towards the eyebox of waveguide display 1100.

Waveguide displays using diffractive optical elements may generally have limited fields of view due to, for example, limited angular/wavelength bandwidths of the diffractive optical elements and limited angular ranges of light supported by the waveguides. For example, as described above with respect to FIGS. 9A, 9B, and 11B, the propagation angles of display light supported by a single waveguide may be bounded by the critical angle for total internal reflection (TIR) and the grazing angle. Gratings such as VBGs may have a narrow angular/wavelength bandwidth. Diffractive optical elements may also have high light dispersion, and thus the fields of view for different colors may be reduced or partially clipped due to the light dispersion and the limited angular ranges of light supported by the waveguide. In order to support a large field of view by a single waveguide, the waveguide may need to have a high refractive index, which may be more expensive and more difficult to make.

In addition, when the incidence angles of the display light incident on surfaces of the waveguide are large, even if the light may be supported by the waveguide, the distance between two consecutive incidences of the display light on the same surface of the waveguide (and being diffracted by gratings) may be large. As such, the pupil replication density may be low and the eyebox may not be fully and uniformly filled with the replicated pupils. Therefore, to fully and more uniformly fill the eyebox, the FOV provided by a single waveguide may be limited.

In some implementations, the full FOV range of a waveguide display may be divided into two or more FOV ranges to be covered by two or more sets of gratings and two or more waveguides. The two or more FOV ranges may be stitched together to provide the full field of view. For each FOV range, a set of gratings and one or more waveguides may be used to expand the exit pupil in two dimensions to fill an eyebox. For example, a first grating may be used to couple display light into a waveguide, a second grating (e.g., a fold grating) may be used to expand the exit pupil in one (e.g., horizontal or vertical) direction, and a third grating may be used to expand the exit pupil in another (e.g., vertical or horizontal) direction. The first grating, second grating, and third grating may be formed on one or two surfaces of the waveguide. In some embodiments, to reduce certain optical artifacts, the two or more sets of gratings may be configured such that the two or more FOV ranges of the full field of view may partially overlap. As such, even if there is a misalignment of the two or more FOV ranges of the full FOV caused by some manufacture errors, the full FOV can still be supported. In some implementations, the full FOV range of a waveguide display may be covered by a single projector. In some implementations, the full FOV may be divided into two or more FOV ranges to be covered by two or more projectors, where light from each projector may be coupled into a waveguide by a respective input coupler.

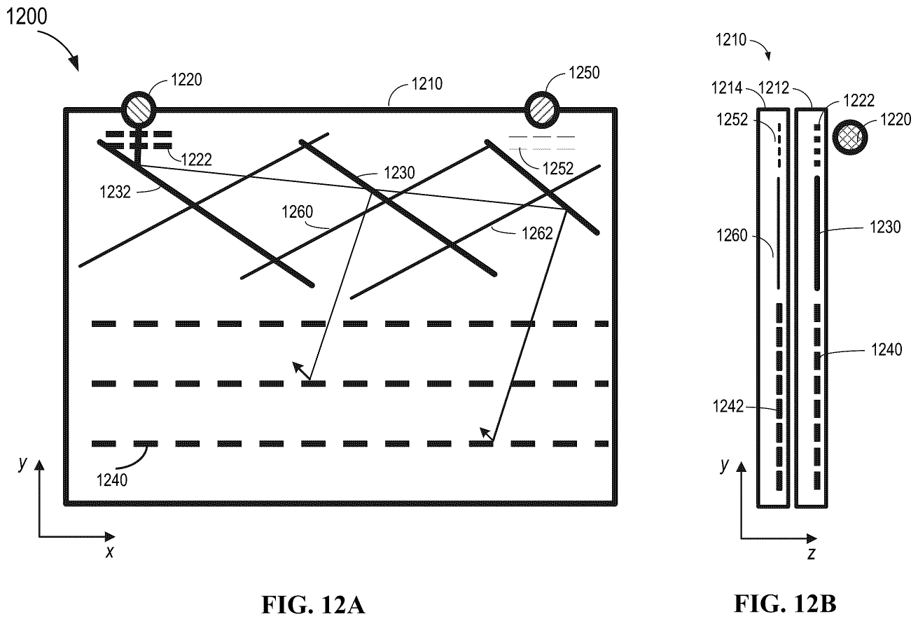

FIG. 12A is a front view of an example of a grating-based waveguide display 1200 including two image projectors 1220 and 1250. FIG. 12B is a side view of the example of grating-based waveguide display 1200 including two image projectors 1220 and 1250. Image projector 1220, a first input grating 1222, a first top grating 1230, and a bottom grating 1240 may be used to provide a first portion (e.g., the left half) of the full FOV of waveguide display 1200. Display light for the first portion of the full FOV may be collimated and projected onto first input grating 1222, which may couple the display light into a waveguide 1210 by diffraction as described above. The display light may reach a first portion 1232 of first top grating 1230 and may be diffracted by first portion 1232 of first top grating 1230 to change the propagation direction and reach other portions of first top grating 1230. Each of the other portions of first top grating 1230 may diffract the display light towards bottom grating 1240. Bottom grating 1240 may diffract the display light out of waveguide 1210 at different locations to form multiple exit pupils as described above. First portion 1232 of first top grating 1230 and each of the other portions of first top grating 1230 may have similar grating parameters, and may compensate the dispersion of display light caused by each other to reduce the overall dispersion due to, for example, the opposite diffraction conditions (e.g., +1 order and −1 order diffractions) for the diffractions at first portion 1232 of first top grating 1230 and each of other portions of first top grating 1230. In addition, first input grating 1222 and bottom grating 1240 may at least partially compensate the dispersion of display light caused by each other to reduce the overall dispersion. due to the opposite diffraction directions and opposite diffraction conditions (e.g., +1 order and −1 order diffractions) for the respective diffractions. In this way, the dispersion by first portion 1232 of first top grating 1230 and each of other portions of first top grating 1230 may be canceled out, and the dispersion by first input grating 1222 and bottom grating 1240 may also be canceled out.

Similarly, image projector 1250, a second input grating 1252, a second top grating 1260, and a bottom grating 1242 may be used to provide another portion (e.g., the right half) of the full FOV of waveguide display 1200. Bottom grating 1242 may be used for both portions of the field of view, or may include two gratings each for a portion of the field of view. The dispersion by a first portion 1262 and each of other portions of second top grating 1260 may be canceled out, and the dispersion by second input grating 1252 and bottom grating 1242 may also be canceled out. Therefore, the overall dispersion of the display light by waveguide display 1200 can be minimized in any direction.

Waveguide display 1200 may include multiple grating layers (e.g., polymer layers or SRGs) on or in one or more waveguides (e.g., substrates), such as a first waveguide 1212 and a second waveguide 1214. The gratings on each grating layer may cover a different respective FOV and/or light spectra. The combination of the multiple grating layers may provide the full FOV and spectral coverage. Input gratings 1222 and 1252, top gratings 1230 and 1260, and bottom gratings 1240 and 1242 may each be formed on or in first waveguide 1212 or second waveguide 1214. For example, first input grating 1222, first top grating 1230, and bottom grating 1240 may be formed on or in first waveguide 1212 to support a first field of view, while second input grating 1252, second top grating 1260, and bottom grating 1242 may be formed on or in second waveguide 1214 to support a second field of view. In this way, a large overall FOV may be achieved, where each waveguide may only need to support a small FOV and can use materials with low refractive indices.

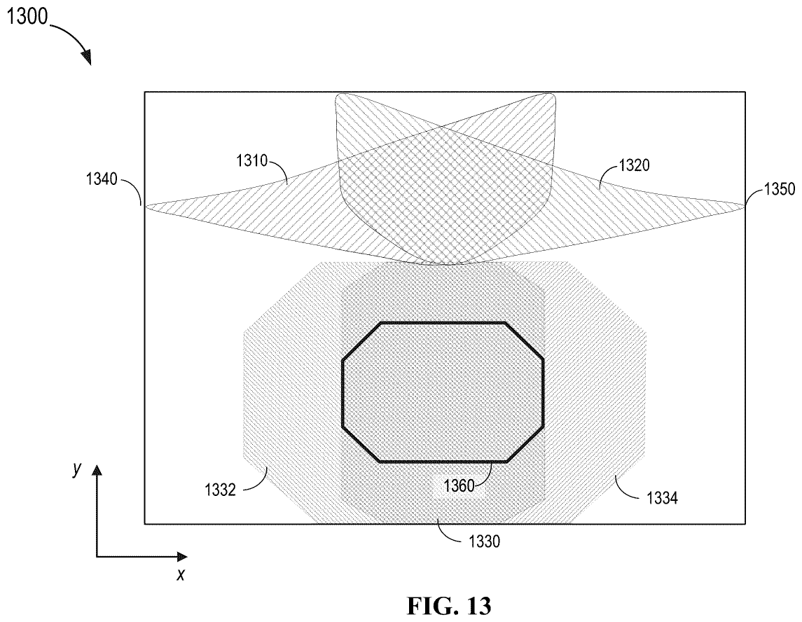

FIG. 13 illustrates an example of a grating-based waveguide display 1300 including two image projectors 1340 and 1350. Waveguide display 1300 may be an example of waveguide display 1200. In the illustrated example, waveguide display 1300 may include a first top grating 1310, a second top grating 1320, and one or more bottom gratings 1330 formed on or in two or more waveguides. An exit region 1360 on bottom gratings 1330 may represent the region where display light for the full FOV at one pupil location in the eyebox (e.g., at the center the eyebox) may be coupled out of waveguide display 1300. Image projector 1340, one or more first input gratings (not shown), first top grating 1310, and a bottom grating 1330 (or a bottom grating 1332 of bottom gratings 1330) may be used to provide about a half (e.g., the left or right half) of the total field of view of waveguide display 1300, while image projector 1350, one or more second input gratings (not shown), second top grating 1320, and a bottom grating 1330 (or a bottom grating 1334 of bottom gratings 1330) may be used to provide about another half (e.g., the right or left half) of the total field of view of waveguide display 1300. In some embodiments, more than two projectors may be used to provide the full field of view of the waveguide display.

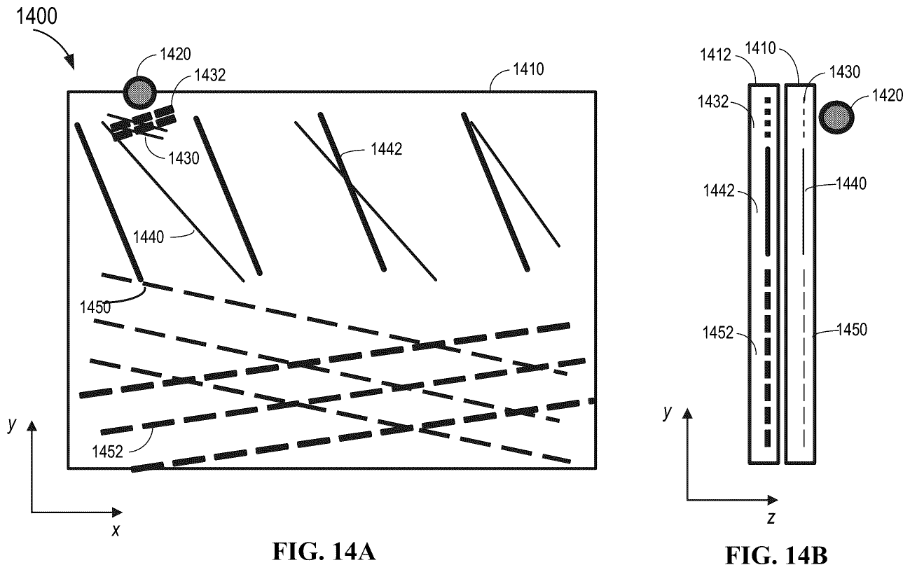

FIG. 14A is a front view of an example of a grating-based waveguide display 1400 including a single image projector 1420 and gratings for field-of-view stitching. FIG. 14B is a side view of the example of grating-based waveguide display 1400 with image projector 1420 and the gratings for field-of-view stitching. Waveguide display 1400 may include multiple grating layers on one or more waveguides 1410 and 1412. Image projector 1420, a waveguide 1410, an input grating 1430, a top grating 1440, and a bottom grating 1450 may be used to provide a first portion (e.g., the left or right half) of the full FOV of waveguide display 1400. As described above, display light for the first portion of the FOV may be collimated and projected onto input grating 1430, which may couple the display light into waveguide 1410 by diffraction as described above. The display light may reach a first portion of top grating 1440 and may be diffracted by the first portion of top grating 1440 to other portions of top grating 1440, which may each diffract the display light towards bottom grating 1450. Bottom grating 1450 may diffract the display light out of waveguide 1410 at different locations to replicate exit pupils as described above. The first portion and each of the other portions of top grating 1440 may compensate for the dispersion caused by each other, and input grating 1430 and bottom grating 1450 may also compensate for the dispersion caused by each other as described above.

Image projector 1420, a waveguide 1412, an input grating 1432, a top grating 1442, and a bottom grating 1452 may be used to provide a portion (e.g., the right or left half) of the full FOV of waveguide display 1400. The display light may be collimated and coupled into waveguide 1412 by input grating 1432. The display light may reach a first portion of top grating 1442 and may be diffracted by the first portion of top grating 1442 to other portions of top grating 1442, which may each diffract the display light towards bottom grating 1452. Bottom grating 1452 may diffract the display light out of waveguide 1412 at different locations to replicate exit pupils as described above. The first portion and each of other portions of top grating 1442 may compensate for the dispersion caused by each other, and input grating 1432 and bottom grating 1452 may also compensate for the dispersion caused by each other as described above.

As shown in, for example, FIGS. 12A-14B, to support multiple FOVs to achieve a large overall FOV, multiple waveguides and multiple projectors and gratings may be needed. For example, two waveguides and the corresponding gratings may be used to cover the full FOV for blue light, two waveguides and the corresponding gratings may be used to cover the full FOV for red light, and the full FOV for green light may be covered by another two waveguides and corresponding gratings, or may be covered by the waveguides and gratings for blue light and/or red light. Therefore, four or more waveguides may be needed for each eye, and eight or more waveguides may be needed for binocular display. In some implementations, one waveguide may be used to cover one half of the full FOV for RGB light, and another waveguide may be used to cover the other half of the full FOV for RGB light, such that two waveguides may be used for a monocular display and four waveguides may be used for a binocular display. Using multiple waveguides and the corresponding projectors and gratings may increase the thickness (and thus weight), manufacturing cost, and alignment difficulty, and may also reduce overall see-through transparency and introduce more display artifacts, such as ghost images, glints, rainbow images, and the like.

According to certain embodiments, a waveguide display may include a waveguide and a two-dimensional (2-D) grating having multiple (e.g., three or more) different grating vectors for replicating display light for multiple FOVs in two dimensions. Multiple grating vectors of the 2-D grating may form a closed polygon (e.g., a triangle). Display light for different FOVs may be coupled into the waveguide by respective input gratings, where the grating vector of each input grating may be similar to a grating vector of the multiple grating vectors of the 2-D grating, such that the grating vector of the input grating and two or more grating vectors of the 2-D grating may form a closed polygon (e.g., triangle) for angle preservation. As such, the 2-D grating may be able to diffract the display light coupled into the waveguide by the input gratings in two or more directions, to perform 2-D pupil replication of display light for two or more different FOVs and being coupled into the waveguide by two or more input gratings.

In some embodiments, the 2-D grating may include a two-dimensional lattice structure that includes a 2-D array of the grating elements, where the grating elements may align long multiple directions at different pitches to function as multiple grating structures having multiple grating vectors. In some embodiments, the 2-D grating may include multiple layers of one-dimensional gratings having different grating vectors. Therefore, the 2-D grating may be able to diffract light that is from multiple FOVs and is coupled into the waveguide by multiple input gratings, where each input grating may be used to couple display light for a respective FOV and may be characterized by a grating vector that matches one of the multiple grating vectors of the 2-D grating. Therefore, a waveguide and the gratings on the waveguide may be able to support multiple FOVs to achieve a desired overall FOV coverage.

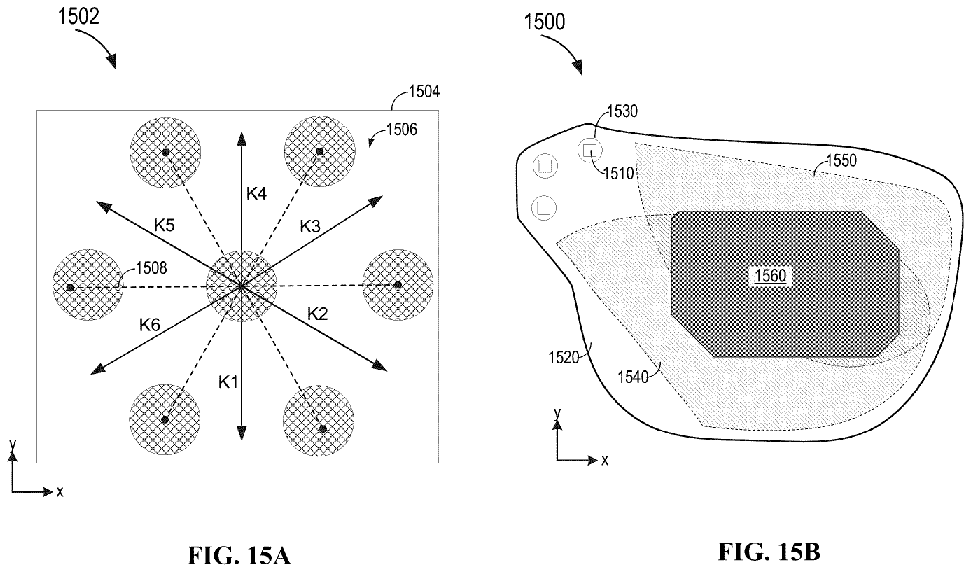

FIG. 15A illustrates an example of a waveguide display 1502 including a two-dimensional (2-D) grating 1506 formed on a waveguide 1504 according to certain embodiments. 2-D grating 1506 may include a two-dimensional array of grating elements 1508 (e.g., pillars, bars, rods, or other micro-structures) that may form a lattice structure. Grating elements 1508 aligned along different directions at different or similar pitches may function as gratings with different grating vectors. For example, grating elements 1508 aligned along the x direction may form a grating that may be characterized by a grating vector K1 or K4, grating elements 1508 aligned along a direction that is about 30° with respect to the y direction may form a grating that may be characterized by a grating vector K2 or K5, while grating elements 1508 aligned along a direction that is about −30° with respect to the y direction may form a grating that may be characterized by a grating vector K3 or K6. Even though not shown in FIG. 15A, grating elements 1508 aligned along other directions (e.g., about ±30° with respect to the x direction) may form gratings characterized by other grating vectors. As such, 2-D grating 1506 may have multiple grating vectors.

FIG. 15B illustrates an example of a waveguide display 1500 including a two-dimensional grating 1560 for two-dimensional pupil expansion and output coupling according to certain embodiments. Waveguide display 1500 may be similar to waveguide display 1100, but may include a 2-D grating 1560, rather than two one-dimensional gratings 1540 and 1550 (e.g., first output grating 1140 and second output grating 1150). In the illustrated example, waveguide display 1500 may include three image sources 1510 (e.g., image projectors or LED arrays described above), a substrate 1520, a set of input couplers 1530 (e.g., gratings), and 2-D grating 1560 for pupil expansion as described above. Input couplers 1530 and 2-D grating 1560 may be attached to or formed (e.g., etched) in substrate 1520. An input coupler 1530 may have a first grating vector, whereas 2-D grating 1560 may have at least a second grating vector and a third grating vector as described with respect to FIG. 15A. The first grating vector, second grating vector, and third grating vector may form a closed triangle as described above.

Image sources 1510 may generate images of red, green, and blue light, respectively. The images generated by image sources 1510 may be coupled into substrate 1520 by the set of input couplers 1530. Display light generated by image sources 1510 and coupled into substrate 1520 by input couplers 1530 may propagate within substrate 1520 through total internal reflection at two opposing broadside surfaces of substrate 1520. During the propagation, the display light may be partially diffracted by 2-D grating 1560 at multiple locations, and may be partially reflected to continue to propagate within substrate 1520. Because 2-D grating 1560 may have two or more different grating vectors, it may replicate the pupil in two dimensions as described above. For example, the in-coupled display light may propagate along a first direction in substrate 1520 and may be diffracted at multiple locations along the first direction by a first sub-grating of 2-D grating 1560 that has the second grating vector, to propagate in a second direction in substrate 1520. The display light propagating along the second direction may be diffracted at multiple locations along the second direction by a second sub-grating of 2-D grating 1560 that has the third grating vector to exit substrate 1520.

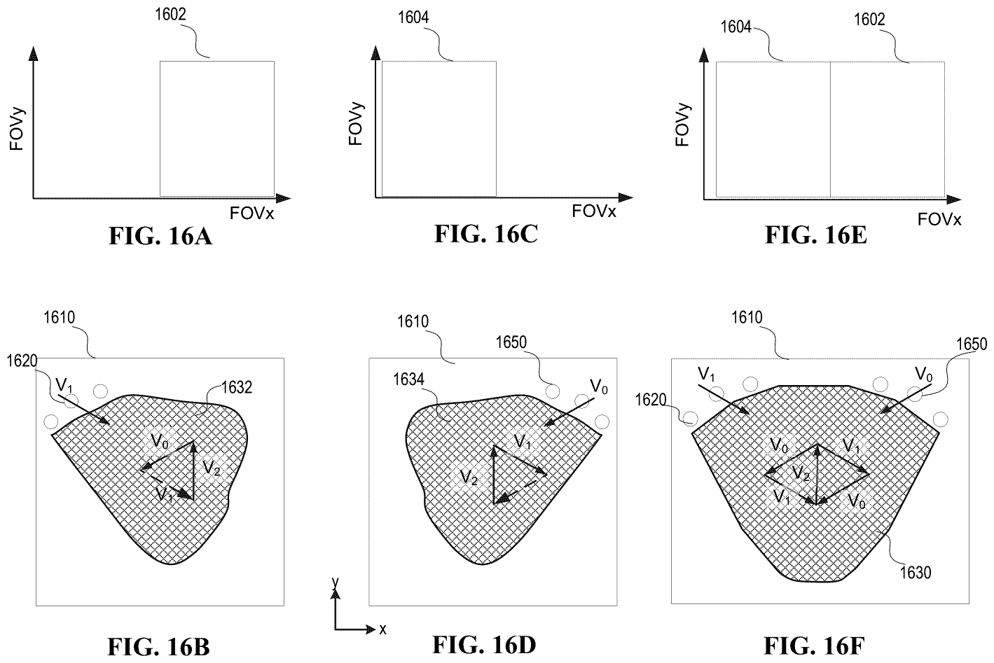

FIGS. 16A-16F illustrate examples of waveguide displays including a two-dimensional grating 1630 and a waveguide 1610 to support multiple fields of view according to certain embodiments. In the illustrated example, the full FOV of the waveguide displays may be divided into two smaller fields of view 1602 and 1604. A first field of view 1602 may be supported by a first display projector assembly (DPA, not shown in FIGS. 16A-16F), a first set of input gratings 1620, and a grating 1632. The first field of view 1602 may be about a half of the desired overall FOV of the waveguide display. The first set of input gratings 1620 and grating 1632 may be on a same side or two opposing sides of waveguide 1610. A second field of view 1604 of the waveguide display may be supported by a second DPA (not shown), a second set of input gratings 1650, and a grating 1634. The second field of view 1604 may be about a half of the desired overall FOV. The second set of input gratings 1650 and grating 1634 may be on a same side or two opposing sides of waveguide 1610. In some embodiments, instead of using two gratings 1632 and 1634, a 2-D grating 1630 having grating vectors V₀, V₁, and V₂ as described above with respect to FIG. 15A may be used. Grating vectors V₀, V₁, and V₂ may form a closed triangle, and may be able to replicate display light coupled into waveguide 1610 by input gratings having a grating vector V₀, V₁, or V₂. In this way, a single waveguide including two sets of input gratings and a 2-D grating formed thereon can support the full FOV that may otherwise need to be supported by at least two waveguides and two sets of gratings.

FIG. 16A shows the first field of view 1602 of a waveguide display. For example, the first field of view 1602 may be a right half of the desired overall FOV of the waveguide display. FIG. 16B shows gratings formed on or in waveguide 1610 for supporting the first field of view 1602. FIG. 16B shows the first set of input gratings 1620 (e.g., three input gratings for coupling red, green, and blue light into waveguide 1610) and grating 1632 for pupil expansion as described above with respect to FIG. 15B. DPAs for projecting red, green, and blue images are not shown in FIG. 16B. Input gratings 1620 and grating 1632 may be attached to or formed (e.g., etched) in waveguide 1610. An input grating 1620 may have a grating vector V₁.

The first DPA may generate images of red, green, and blue light. The images generated by the first DPA may be coupled into waveguide 1610 by respective input gratings 1620 (e.g., having a grating vector V₁). Display light coupled into waveguide 1610 by input gratings 1620 may propagate within waveguide 1610 through total internal reflection at two opposing broadside surfaces of waveguide 1610. During the propagation, the display light may be partially diffracted by grating 1632 at multiple locations, and may be partially reflected to continue to propagate within waveguide 1610. The in-coupled display light may first propagate along a first direction in waveguide 1610 and may be diffracted at multiple locations along the first direction by a first sub-grating of grating 1632 that may have a grating vector V₂ to propagate in a second direction in waveguide 1610. The display light propagating along the second direction may be diffracted at multiple locations along the second direction by a second sub-grating of grating 1632 that has a grating vector V₀ to exit waveguide 1610.

FIG. 16C shows the second field of view 1604 of the waveguide display. For example, the second field of view 1604 may be a left half of the desired overall FOV of the waveguide display. FIG. 16D shows gratings formed on or in waveguide 1610 for supporting the second field of view 1602. FIG. 16B shows the second set of input gratings 1650 (e.g., three input gratings for coupling red, green, and blue light into waveguide 1610) and grating 1634 for pupil expansion as described above with respect to FIG. 15B. DPAs for projecting red, green, and blue images are not shown in FIG. 16D. Input gratings 1650 and grating 1634 may be attached to or formed (e.g., etched) in waveguide 1610. An input grating 1650 may have a grating vector V₀.

The second DPA may generate images of red, green, and blue light. The images generated by the second DPA may be coupled into waveguide 1610 by respective input gratings 1650 (e.g., having a grating vector V₀). Display light coupled into waveguide 1610 by input gratings 1650 may propagate within waveguide 1610 through total internal reflection at two opposing broadside surfaces of waveguide 1610. During the propagation, the display light may be partially diffracted by grating 1634 at multiple locations, and may be partially reflected to continue to propagate within waveguide 1610. The in-coupled display light may first propagate along a third direction in waveguide 1610 and may be diffracted at multiple locations along the third direction by the first sub-grating of grating 1634 that has a grating vector V₂ to propagate in a fourth direction in waveguide 1610, and the display light propagating along the fourth direction may be diffracted at multiple locations along the fourth direction by a third sub-grating of grating 1634 that has a grating vector V₁ to exit waveguide 1610.

FIG. 16E shows that first FOV 1602 and second FOV 1604 may be stitched to provide the full FOV of a waveguide display. In some embodiments, first FOV 1602 and second FOV 1604 may overlap at the center FOV. FIG. 16F shows that input gratings 1620, input gratings 1650, and 2-D grating 1630 may be formed on one side or two sides of waveguide 1610, which may be a single transparent substrate. 2-D grating 1630 may have grating vectors V₀, V₁, and V₂, and thus may perform 2-D pupil replication on display light coupled into waveguide 1610 by input gratings 1620 (e.g., having a grating vector V₁) and input gratings 1650 (e.g., having a grating vector V₀).

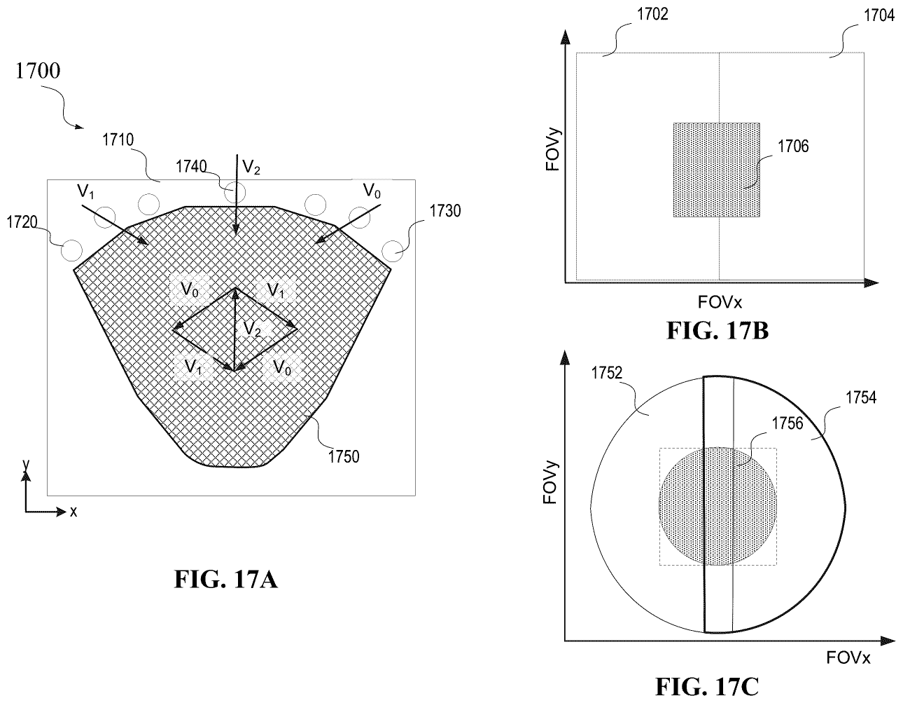

FIG. 17A illustrates an example of a waveguide display 1700 including a two-dimensional grating 1750 supporting multiple fields of view according to certain embodiments. FIG. 17B illustrates an example of the field of view of waveguide display 1700 according to certain embodiments. In the illustrated example, the full FOV of waveguide display 1700 may be achieved by stitching three FOVs 1702, 1704, and 1706. FOVs 1702 and 1704 may be supported by a first set of input gratings 1720, a second set of input gratings 1730, and 2-D grating 1750 formed on or in a waveguide 1710, as described above with respect to FIG. 16A-16F. Waveguide display 1700 may also include multiple DPAs (not shown) for generating and projecting color or monochromatic images. 2-D grating 1750 may be characterized by at least three different grating vectors V₀, V₁, and V₂ that may form a closed triangle.

A third set of one or more input gratings 1740 having a grating vector V₂ may be formed on waveguide 1710 and may be used to couple display light for FOV 1706 of the waveguide display from a DPA into waveguide 1710, where 2-D grating 1750 having grating vectors V₀, V₁, and V₂ may replicate the display light for FOV 1706 in two dimensions as described above. The third FOV 1706 may be stitched together with FOVs 1702 and 1706 to further increase the full FOV of the waveguide display, or may be used as an inset FOV to provide improved display quality for a center FOV of the waveguide display. Without using 2-D grating 1750 disclosed herein, three or more waveguides may be needed to be used to stitch the three FOVs to provide the same full FOV.

FIG. 17C illustrates another example of the field of view of waveguide display 1700 including two-dimensional grating 1750 according to certain embodiments. In the example illustrated in FIG. 17C, the full FOV of waveguide display 1700 may be achieved by stitching three FOVs 1752, 1754, and 1756. FOVs 1752, 1754, and 1756 may be supported by first set of input gratings 1720, second set of input gratings 1730, third set of one or more input gratings 1740, and 2-D grating 1750 formed on or in a waveguide 1710. In the illustrated example, FOV 1752 may cover a left portion of the full FOV of waveguide display 1700, FOV 1754 may cover a right portion of the full FOV of waveguide display 1700, and there may be some overlap (e.g., about) 10° between FOV 1752 and FOV 1754. FOV 1752 and FOV 1754 may, in combination, cover approximately the full FOV of waveguide display 1700. FOV 1756 may cover a center portion of the full FOV, and may be stitched together with FOVs 1752 and 1756 to increase the full FOV of waveguide display 1700 or to provide improved display quality for the center portion of the full FOV of waveguide display 1700.

Even though FIGS. 16A-17C show examples of stitching multiple FOVs having different FOVs in the x direction to provide full FOV, multiple FOVs having different FOVs in the y direction (or another different direction) may be provided using techniques disclosed herein and may be stitched to provide the full FOV. The multiple FOVs may include two, three, or more FOVs. The multiple FOVs may partially overlap or may not overlap, and may be supported by a single waveguide and gratings (e.g., including a 2-D grating) formed on or in the waveguide. The 2-D grating may have three, four, or more grating vectors, to support two or more FOVs.

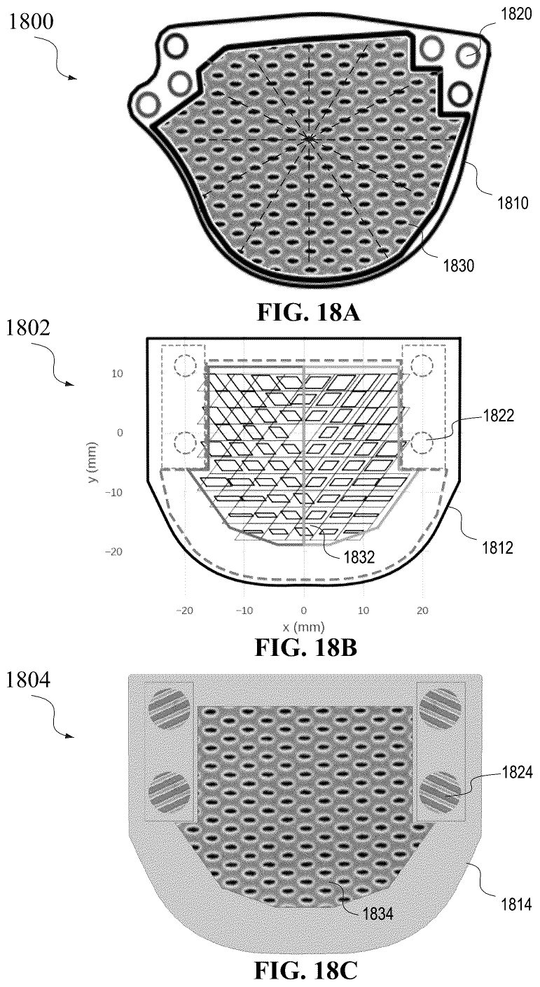

FIGS. 18A-18C illustrate examples of waveguide displays including two-dimensional gratings according to certain embodiments. FIG. 18A illustrates an example of a waveguide display 1800 including a waveguide 1810 (e.g., a transparent substrate), one or more input couplers 1820, and a two-dimensional grating 1830. Two-dimensional grating 1830 may be a surface-relief grating including a two-dimensional array of grating ridges or grating grooves that have shapes of ellipses, where orientations of the ellipses may or may not vary across two-dimensional grating 1830.

FIG. 18B illustrates an example of a waveguide display 1802 including a waveguide 1812 (e.g., a transparent substrate), one or more input couplers 1822, and a two-dimensional grating 1832. Two-dimensional grating 1832 may be a surface-relief grating including a two-dimensional array of grating ridges or grating grooves that have shapes of parallelograms, where sizes and orientations of the parallelograms may or may not vary across two-dimensional grating 1832.

FIG. 18C illustrates an example of a waveguide display 1804 including a waveguide 1814 (e.g., a transparent substrate), one or more input couplers 1824, and a two-dimensional grating 1834. Input couplers 1824 may include one-dimensional gratings having desired grating vectors. Two-dimensional grating 1834 may be a surface-relief grating including a two-dimensional array of grating ridges or grating grooves that have shapes of ellipses, where orientations of the ellipses may or may not vary across two-dimensional grating 1830.

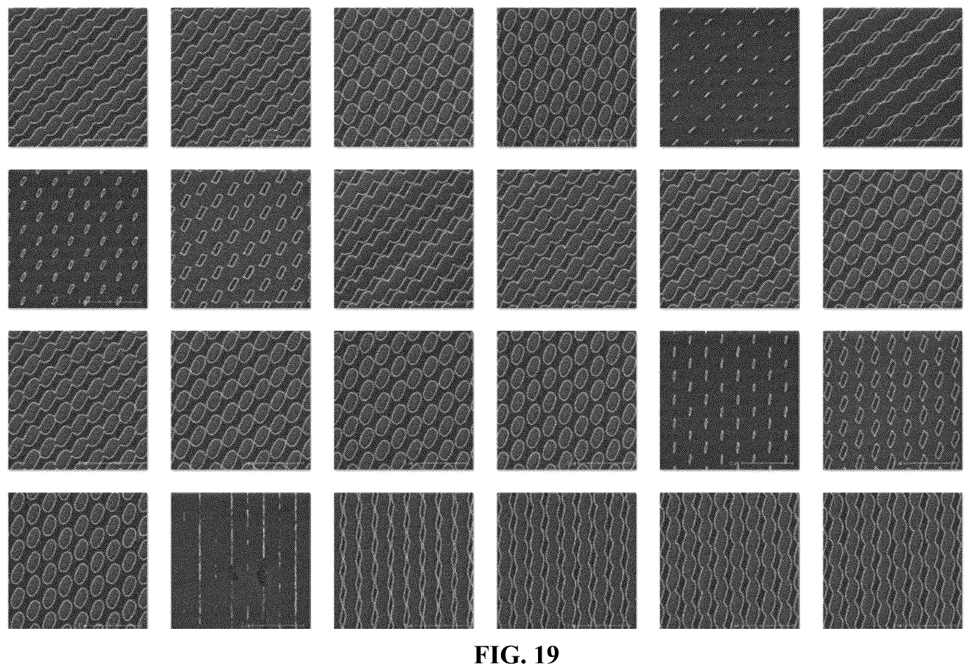

FIG. 19 illustrates some other examples of two-dimensional gratings that may be used to implement the waveguide displays disclosed herein according to certain embodiments. The two-dimensional gratings may be surface-relief gratings with two-dimensional arrays of grating elements in the shapes of, for example, ellipses and/or parallelograms. The shapes, sizes, orientations, packing densities, and alignment directions of the grating elements may be selected to achieve the desired grating vectors and performance. It is noted that the examples shown in FIG. 19 are for illustration purposes only. Other two-dimensional gratings having different shapes, sizes, orientations, packing densities, and alignment directions of the grating elements may also be used according to techniques disclosed herein to support multiple FOVs in waveguide displays.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

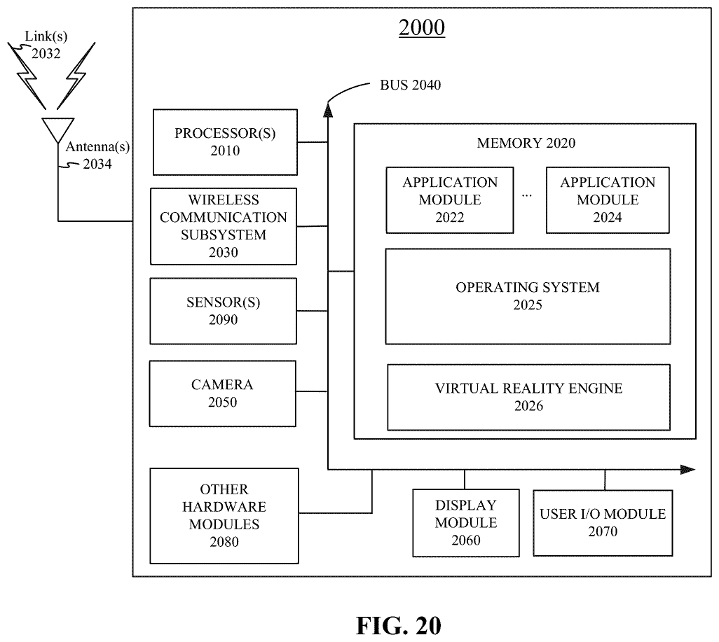

FIG. 20 is a simplified block diagram of an electronic system 2000 of an example near-eye display (e.g., HMD device) for implementing some of the examples disclosed herein. Electronic system 2000 may be used as the electronic system of an HMD device or other near-eye displays described above. In this example, electronic system 2000 may include one or more processor(s) 2010 and a memory 2020. Processor(s) 2010 may be configured to execute instructions for performing operations at a number of components, and can be, for example, a general-purpose processor or microprocessor suitable for implementation within a portable electronic device. Processor(s) 2010 may be communicatively coupled with a plurality of components within electronic system 2000. To realize this communicative coupling, processor(s) 2010 may communicate with the other illustrated components across a bus 2040. Bus 2040 may be any subsystem adapted to transfer data within electronic system 2000. Bus 2040 may include a plurality of computer buses and additional circuitry to transfer data.

Memory 2020 may be coupled to processor(s) 2010. In some embodiments, memory 2020 may offer both short-term and long-term storage and may be divided into several units. Memory 2020 may be volatile, such as static random access memory (SRAM) and/or dynamic random access memory (DRAM) and/or non-volatile, such as read-only memory (ROM), flash memory, and the like. Furthermore, memory 2020 may include removable storage devices, such as secure digital (SD) cards. Memory 2020 may provide storage of computer-readable instructions, data structures, program modules, and other data for electronic system 2000. In some embodiments, memory 2020 may be distributed into different hardware modules. A set of instructions and/or code might be stored on memory 2020. The instructions might take the form of executable code that may be executable by electronic system 2000, and/or might take the form of source and/or installable code, which, upon compilation and/or installation on electronic system 2000 (e.g., using any of a variety of generally available compilers, installation programs, compression/decompression utilities, etc.), may take the form of executable code.

In some embodiments, memory 2020 may store a plurality of application modules 2022 through 2024, which may include any number of applications. Examples of applications may include gaming applications, conferencing applications, video playback applications, or other suitable applications. The applications may include a depth sensing function or eye tracking function. Application modules 2022-2024 may include particular instructions to be executed by processor(s) 2010. In some embodiments, certain applications or parts of application modules 2022-2024 may be executable by other hardware modules 2080. In certain embodiments, memory 2020 may additionally include secure memory, which may include additional security controls to prevent copying or other unauthorized access to secure information.

In some embodiments, memory 2020 may include an operating system 2025 loaded therein. Operating system 2025 may be operable to initiate the execution of the instructions provided by application modules 2022-2024 and/or manage other hardware modules 2080 as well as interfaces with a wireless communication subsystem 2030 which may include one or more wireless transceivers. Operating system 2025 may be adapted to perform other operations across the components of electronic system 2000 including threading, resource management, data storage control and other similar functionality.

Wireless communication subsystem 2030 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 2000 may include one or more antennas 2034 for wireless communication as part of wireless communication subsystem 2030 or as a separate component coupled to any portion of the system. Depending on desired functionality, wireless communication subsystem 2030 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN.

Wireless communications subsystem 2030 may permit data to be exchanged with a network, other computer systems, and/or any other devices described herein. Wireless communication subsystem 2030 may include a means for transmitting or receiving data, such as identifiers of HMD devices, position data, a geographic map, a heat map, photos, or videos, using antenna(s) 2034 and wireless link(s) 2032. Wireless communication subsystem 2030, processor(s) 2010, and memory 2020 may together comprise at least a part of one or more of a means for performing some functions disclosed herein.

Embodiments of electronic system 2000 may also include one or more sensors 2090. Sensor(s) 2090 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 2090 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or any combination thereof. The position sensors may be located external to the IMU, internal to the IMU, or any combination thereof. At least some sensors may use a structured light pattern for sensing.

Electronic system 2000 may include a display module 2060. Display module 2060 may be a near-eye display, and may graphically present information, such as images, videos, and various instructions, from electronic system 2000 to a user. Such information may be derived from one or more application modules 2022-2024, virtual reality engine 2026, one or more other hardware modules 2080, a combination thereof, or any other suitable means for resolving graphical content for the user (e.g., by operating system 2025). Display module 2060 may use LCD technology, LED technology (including, for example, OLED, ILED, μ-LED, AMOLED, TOLED, etc.), light emitting polymer display (LPD) technology, or some other display technology.

Electronic system 2000 may include a user input/output module 2070. User input/output module 2070 may allow a user to send action requests to electronic system 2000. An action request may be a request to perform a particular action. For example, an action request may be to start or end an application or to perform a particular action within the application. User input/output module 2070 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 2000. In some embodiments. user input/output module 2070 may provide haptic feedback to the user in accordance with instructions received from electronic system 2000. For example, the haptic feedback may be provided when an action request is received or has been performed.

Electronic system 2000 may include a camera 2050 that may be used to take photos or videos of a user, for example, for tracking the user's eye position. Camera 2050 may also be used to take photos or videos of the environment, for example, for VR, AR, or MR applications. Camera 2050 may include, for example, a complementary metal-oxide-semiconductor (CMOS) image sensor with a few millions or tens of millions of pixels. In some implementations, camera 2050 may include two or more cameras that may be used to capture 3-D images.

In some embodiments, electronic system 2000 may include a plurality of other hardware modules 2080. Each of other hardware modules 2080 may be a physical module within electronic system 2000. While each of other hardware modules 2080 may be permanently configured as a structure, some of other hardware modules 2080 may be temporarily configured to perform specific functions or temporarily activated. Examples of other hardware modules 2080 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 2080 may be implemented in software.

In some embodiments, memory 2020 of electronic system 2000 may also store a virtual reality engine 2026. Virtual reality engine 2026 may execute applications within electronic system 2000 and receive position information, acceleration information, velocity information, predicted future positions, or any combination thereof of the HMD device from the various sensors. In some embodiments, the information received by virtual reality engine 2026 may be used for producing a signal (e.g., display instructions) to display module 2060. For example, if the received information indicates that the user has looked to the left, virtual reality engine 2026 may generate content for the HMD device that mirrors the user's movement in a virtual environment. Additionally, virtual reality engine 2026 may perform an action within an application in response to an action request received from user input/output module 2070 and provide feedback to the user. The provided feedback may be visual, audible, or haptic feedback. In some implementations, processor(s) 2010 may include one or more GPUs that may execute virtual reality engine 2026.

In various implementations, the above-described hardware and modules may be implemented on a single device or on multiple devices that can communicate with one another using wired or wireless connections. For example, in some implementations, some components or modules, such as GPUs, virtual reality engine 2026, and applications (e.g., tracking application), may be implemented on a console separate from the head-mounted display device. In some implementations, one console may be connected to or support more than one HMD.

In alternative configurations, different and/or additional components may be included in electronic system 2000. Similarly, functionality of one or more of the components can be distributed among the components in a manner different from the manner described above. For example, in some embodiments, electronic system 2000 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and C, such as AB, AC, BC, AA, ABC. AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A waveguide display comprising:
a substrate transparent to visible light;
a first projector configured to generate display light for a first field of view (FOV) of the waveguide display;
a first input grating characterized by a first grating vector and configured to couple the display light for the first FOV into the substrate;
a second projector configured to generate display light for a second FOV of the waveguide display that is different from the first FOV;
a second input grating characterized by a second grating vector and configured to couple the display light for the second FOV into the substrate; and
a two-dimensional grating having the first grating vector, the second grating vector, and a third grating vector, wherein:
the first grating vector, the second grating vector, and the third grating vector form a closed triangle;
the two-dimensional grating is configured to couple the display light for the first FOV out of the substrate at a first two-dimensional array of locations of the substrate; and
the two-dimensional grating is further configured to couple the display light for the second FOV out of the substrate at a second two-dimensional array of locations of the substrate.

2. The waveguide display of claim 1, wherein the first FOV and the second FOV in combination include a full field of view of the waveguide display.

3. The waveguide display of claim 1, wherein:
the first FOV includes a left FOV of the waveguide display; and
the second FOV includes a right FOV of the waveguide display.

4. The waveguide display of claim 1, wherein:
the first FOV includes a top FOV of the waveguide display; and
the second FOV includes a bottom FOV of the waveguide display.

5. The waveguide display of claim 1, wherein the two-dimensional grating includes a two-dimensional array of grating elements aligned along a plurality of directions.

6. The waveguide display of claim 5, wherein the grating elements include micro-pillars, micro-bars, micro-rods, micro-cavities, or other micro-structures.

7. The waveguide display of claim 5, wherein the two-dimensional array of grating elements forms a lattice structure.

8. The waveguide display of claim 1, wherein the two-dimensional array of grating elements includes a plurality of layers of one-dimensional gratings.

9. The waveguide display of claim 1, wherein the first FOV and the second FOV at least partially overlap.

10. The waveguide display of claim 1, further comprising:
a third projector configured to generate display light for a third FOV of the waveguide display; and
a third input grating characterized by the third grating vector and configured to couple the display light for the third FOV into the substrate,
wherein the two-dimensional grating is configured to couple the display light for the third FOV out of the substrate at a third two-dimensional array of locations of the substrate.

11. The waveguide display of claim 1, wherein the first projector is configured to generate red, green, and blue display light for the first FOV of the waveguide display.

12. The waveguide display of claim 11, wherein the first input grating includes three input gratings for couple the red, green, and blue display light, respectively.

13. The waveguide display of claim 1, wherein the first input grating, the second input grating, and the two-dimensional grating include surface-relief gratings (SRGs), polarization volume holograms (PVHs), volume Bragg gratings (VBGs), polymer dispersed liquid crystal (PDLC) gratings, or a combination thereof.

14. The waveguide display of claim 1, wherein the first input grating, the second input grating, and the two-dimensional grating are formed on one side or two opposing sides of the substrate.

15. A waveguide display comprising:
a substrate transparent to visible light;
a first input grating characterized by a first grating vector and configured to couple display light for a first field of view (FOV) of the waveguide display into the substrate;
a second input grating characterized by a second grating vector and configured to couple display light for a second FOV of the waveguide display into the substrate; and
a two-dimensional grating having the first grating vector, the second grating vector, and a third grating vector, wherein:
the first grating vector, the second grating vector, and the third grating vector form a closed triangle;
the two-dimensional grating is configured to couple the display light for the first FOV out of the substrate at a first two-dimensional array of locations of the substrate; and
the two-dimensional grating is further configured to couple the display light for the second FOV out of the substrate at a second two-dimensional array of locations of the substrate,
wherein the first input grating, the second input grating, and the two-dimensional grating are on or in the substrate.

16. The waveguide display of claim 15, wherein the first FOV and the second FOV in combination include a full field of view of the waveguide display.

17. The waveguide display of claim 15, wherein the two-dimensional grating includes:
a two-dimensional array of grating elements, the two-dimensional array of grating elements including grating elements aligned along a plurality of directions to form a plurality of gratings characterized by different grating vectors; or
a plurality of layers of one-dimensional gratings characterized by different grating vectors.

18. The waveguide display of claim 15, wherein the first FOV and the second FOV at least partially overlap.

19. The waveguide display of claim 15, wherein the first input grating includes three input gratings for couple red, green, and blue display light, respectively, into the substrate.

20. The waveguide display of claim 15, further comprising:
a third input grating characterized by the third grating vector and configured to couple the display light for a third FOV of the waveguide display into the substrate,
wherein the two-dimensional grating is configured to couple the display light for the third FOV out of the substrate at a third two-dimensional array of locations of the substrate.
